(19) United States
(12) Patent Application Publication
(10) Pub. No.: US 2022/0020313 A1
(43) Pub. Date: Jan. 20, 2022

(54) DRIVING METHOD OF A DISPLAY PANEL

(71) Applicant: HANNSTAR DISPLAY CORPORATION, Taipei City (TW)

(72) Inventors: Cheng-Yen Yeh, Taichung City (TW); I-Hsuan Chen, Kaohsiung City (TW); Mu-Kai Kang, Tainan City (TW); Sz-Kai Huang, Taichung City (TW)

(73) Assignee: HANNSTAR DISPLAY CORPORATION, Taipei City (TW)

(21) Appl. No.: 17/349,852

(22) Filed: Jun. 16, 2021

(30) Foreign Application Priority Data
Jul. 15, 2020 (CN) 202010682577.0

(51) Int. Cl. G09G 3/20

(52) U.S. Cl. CPC G09G 3/2092; G09G 2310/0267; G09G 2310/0286; G09G 2310/0275

(57) ABSTRACT

A driving method of a display panel is provided by the present invention. First, a display panel including sub-pixels, gate lines, two gate driver circuits and clock signal lines is provided. Each of the gate lines is electrically connected to a portion of the sub-pixels, and each of the gate lines is electrically connected to one of the gate driver circuits. Each of the gate driver circuits is electrically connected to a portion of the clock signal lines. Moreover, the gate driver circuits is controlled through the clock signal lines to output scan signals to the gate lines in a plurality of frames. Furthermore, make the gate driver circuits have a first scan order in a first frame, and make the gate driver circuits have a second scan order in a second frame, and the first scan order is different from the second scan order.

### BACKGROUND OF THE INVENTION

### 1. Field of the Invention

The present invention relates to a driving method of a display panel, more particularly to a driving method capable of reducing the power consumption of a display panel.

### 2. Description of the Prior Art

Display panels include two substrates and a plurality of layers and various electronic components disposed between the substrates to perform image display function. Since display panels are thin and light, have low power consumption and no radiation pollution, they are widely used in various portable or wearable electronic products, such as notebooks, smart phones, watches, and vehicle displays, to provide more convenient information transmission and display.

The width of the frame of the display panel is continuously reduced according to requirements, and the space for disposing circuits in the peripheral region is reduced as well. Therefore, the number of the signal lines in the peripheral region should be reduced. In addition, the power consumed by the display panel should not be too high to maintain the quality of the display panel.

### SUMMARY OF THE INVENTION

A driving method of a display panel is provided by the present invention in order to solve the above-mentioned technical problems, the frame width of the display panel can be reduced, and the power consumption of the display panel can be reduced.

In order to solve the above-mentioned technical problems, a driving method of a display panel is provided by the present invention, the driving method comprises following steps. First, a display panel is provided, wherein the display panel comprises a plurality of sub-pixels, a plurality of gate lines and two gate driver circuits. The sub-pixels are arranged in an array. The gate lines are arranged side by side along a first direction, and each of the gate lines is electrically connected to a portion of the sub-pixels. Each of the gate driver circuits includes a plurality of clock signal lines, and each of the gate lines is electrically connected to one of the gate driver circuits. Additionally, controlling the gate driver circuits through the clock signal lines to output a plurality of scan signals to the gate lines in a plurality of frames. Additionally, making the gate driver circuits have a first scan order in a first frame in the frames, and making the gate driver circuits have a second scan order in a second frame in the frames, and the first scan order is different from the second scan order, wherein the first frame is a k^{th} frame in the frames, the second frame is a (k+1)^{th} frame in the frames, and k is a positive integer greater than or equal to 1.

In the driving method of the display panel of the present invention, the display region of the display panel may include the structure shown in FIG. 2, and the connecting method of the gate driver circuits may be shown in FIG. 5. In addition, the gate driver circuits can output the scan signals to the corresponding gate lines in a multihop manner, thereby reducing the number of times that the data lines are turned on and turned off to transmit signals, thereby reducing the power consumption of the display panel. Furthermore, the scan orders of the gate driver circuits can be different from each other in at least two continuous frames. Therefore, the locations of the horizontal stripes caused by insufficient charging of the signal output by the data lines can be different in different frames, and it is difficult for users to perceive the horizontal stripes, thereby improving the quality of display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a display panel according to a first embodiment of the present invention.

FIG. 2 schematically illustrates an enlarged view of an area of a display region shown in FIG. 1.

FIG. 3 schematically illustrates a scan order of a gate driver circuit in a frame according to the first embodiment of the present invention.

FIG. 4 schematically illustrates a scan order of the gate driver circuit in another frame according to the first embodiment of the present invention.

FIG. 5 schematically illustrates a gate driver circuit according to the first embodiment of the present invention.

FIG. 6 schematically illustrates an equivalent circuit diagram of an i^{th}-level shift register of the gate driver circuit shown in FIG. 5.

FIG. 7 illustrates a timing diagram of the gate driver circuit shown in FIG. 5.

FIG. 8 schematically illustrates a flow chart of a driving method of a display panel according to the first embodiment of the present invention.

FIG. 9 schematically illustrates a scan order of a gate driver circuit in a frame according to a second embodiment of the present invention.

FIG. 10 illustrates a timing diagram of a gate driver circuit according to the second embodiment of the present invention.

FIG. 11 schematically illustrates a scan order of a gate driver circuit in a frame according to a third embodiment of the present invention.

FIG. 12 illustrates a timing diagram of a gate driver circuit according to the third embodiment of the present invention.

FIG. 13 schematically illustrates a scan order of a gate driver circuit in a frame according to a fourth embodiment of the present invention.

FIG. 14 illustrates a timing diagram of a gate driver circuit according to the fourth embodiment of the present invention.

FIG. 15 schematically illustrates a scan order of a gate driver circuit in a frame according to a fifth embodiment of the present invention.

FIG. 16 illustrates a timing diagram of a gate driver circuit according to the fifth embodiment of the present invention.

### DETAILED DESCRIPTION

To provide a better understanding of the present invention to those skilled in the technology, preferred embodiments will be detailed as follows. The preferred embodiments of the present invention are illustrated in the accompanying drawings with numbered elements to elaborate on the contents and effects to be achieved. It should be noted that the drawings are simplified schematics, and therefore show only the components and combinations associated with the present invention, so as to provide a clearer description of the basic architecture or method of implementation. The components would be complex in reality. In addition, for ease of explanation, the components shown in the drawings may not represent their actual number, shape, and dimensions; details can be adjusted according to design requirements.

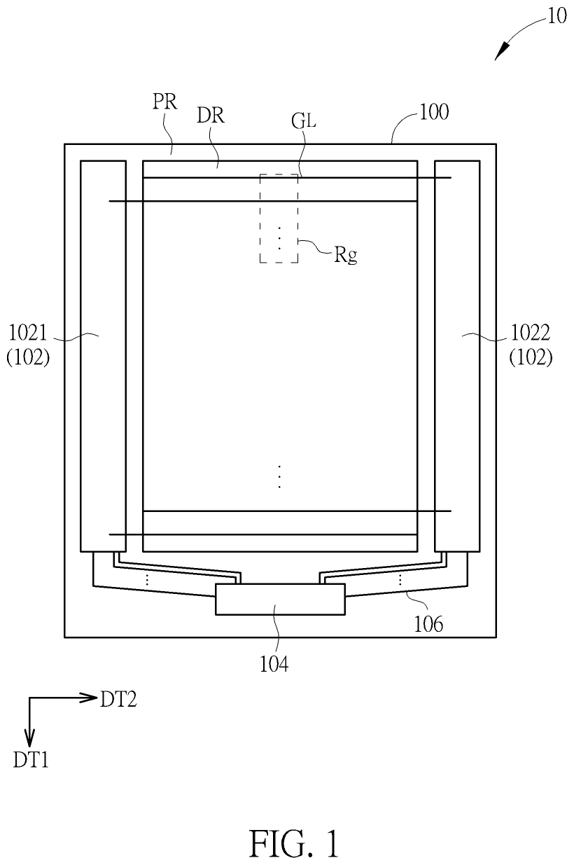

Referring to FIG. 1, FIG. 1 schematically illustrates a display panel according to a first embodiment of the present invention. A display panel 10 of the present invention can be various types of display panels, such as a liquid crystal display panel, an electrophoretic display panel, an organic light emitting display (OLED) panel, or a micro light emitting diode (micro LED) display panel, but not limited thereto. As shown in FIG. 1, a substrate 100 of the display panel 10 has a surface, and the surface includes a display region DR and a peripheral region PR disposed on at least one side of the display region DR. In this embodiment, the peripheral region PR surrounds the display region DR, but not limited thereto. The substrate 100 may be a rigid substrate such as glass substrate, plastic substrate, quartz substrate or sapphire substrate, or may be a flexible substrate including polyimide (PI) or polyethylene terephthalate (PET), but not limited thereto.

The display panel 10 may include a plurality of gate lines GL disposed in the display region DR, the gate lines GL may for example extend into the display region DR from the peripheral region PR, and each of the gate lines GL may be electrically connected to a portion of the sub-pixels in the display region DR. In some embodiments, the plurality of gate lines GL may be arranged side by side along a first direction DT1, and the gate lines GL may extend along a second direction DT2, but not limited thereto. As shown in FIG. 1, the second direction DT2 may not be parallel to the first direction DT1, and the second direction DT2 may be perpendicular to the first direction DT1, but not limited thereto.

The display panel 10 may include at least one gate driver circuit 102 disposed in the peripheral region PR, and the gate driver circuit 102 is disposed on one side of the display region DR. The gate driver circuit 102 can be electrically connected to the gate lines GL, and the gate driver circuit 102 can output a plurality of scan signals to the gate lines GL in a plurality of frames, so as to drive the sub pixels in the display region DR. In addition, the gate driver circuit 102 may be electrically connected to at least one integrated circuit (IC) 104, and the integrated circuit 104 may transmit control signals (such as clock signals, initial signals, and ending signals) to the gate driver circuit 102. The integrated circuit 104 may be disposed in the peripheral region PR, but not limited thereto. In other embodiments, the integrated circuit 104 may be disposed on a circuit board (for example, a flexible printed circuit (FPC)), and then, the integrated circuit 104 can be electrically connected to the connecting pads on the substrate 100, and the connecting pads are electrically connected to the gate driver circuit 102.

In this embodiment, the display panel 10 may include two gate driver circuits 1021, 1022 respectively disposed on both sides of the display region DR, and each of the gate lines GL may be electrically connected to one of the gate driver circuits 1021, 1022. As shown in FIG. 1, for the adjacent two gate lines GL, one of the gate lines GL may be electrically connected to the gate driver circuit 1021, and the other one of the gate lines GL may be electrically connected to the gate driver circuit 1022. For example, the odd-numbered gate lines GL may be electrically connected to the gate driver circuit 1022, and the even-numbered gate lines GL may be electrically connected to the gate driver circuit 1021, but not limited thereto. In some embodiments, the odd-numbered gate lines GL may be electrically connected to the gate driver circuit 1021, and the even-numbered gate lines GL may be electrically connected to the gate driver circuit 1022.

The circuit structures of the gate driver circuits 102 shown in FIG. 1 are gate driver on array (GOA), but not limited thereto. In some embodiments, the gate driver circuit 102 may be fabricated as a chip and disposed on the substrate 100, or the gate driver circuit 102 may be fabricated on a flexible or rigid circuit board and electrically connected to connecting pads disposed on the substrate 100, and the connecting pads can be electrically connected to the gate lines GL. For example, the gate driver circuit 102 may include a plurality of shift registers and a plurality of signal lines (such as clock signal lines and control signal lines), each of the signal lines is electrically connected to at least one of the shift registers, and the signal lines may be electrically connected to the integrated circuit 104 through wires 106, such that the integrated circuit 104 may transmit control signals (such as clock signals and control signals) to the gate driver circuit 102.

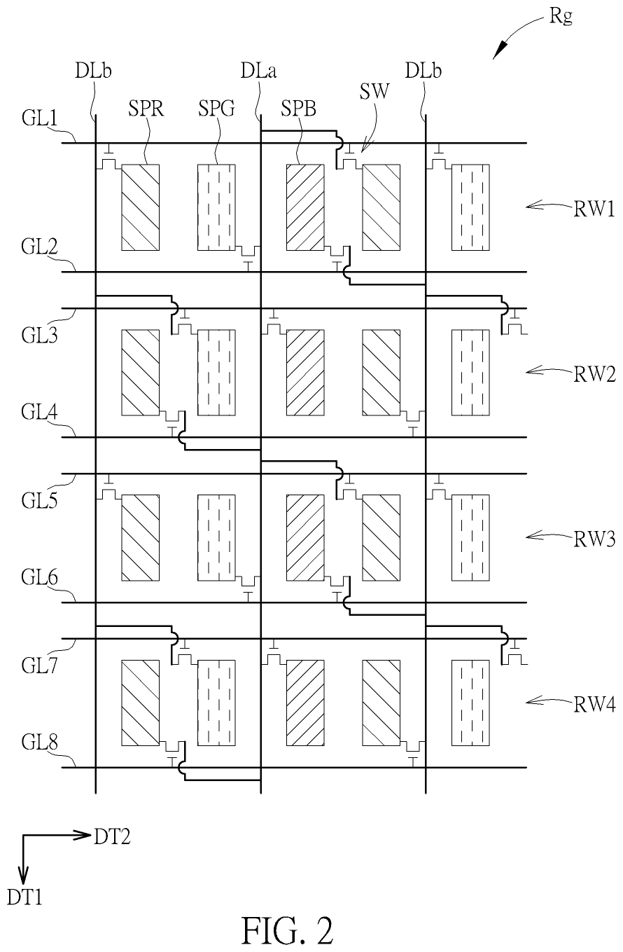

Referring to FIG. 2, FIG. 2 schematically illustrates an enlarged view of an area Rg of the display region DR shown in FIG. 1. In the display region DR, the sub-pixels may be arranged in an array, the sub-pixels may be arranged along the first direction DT1 to form a plurality of sub-pixel columns, and the sub-pixels may be arranged along the second direction DT2 to form a plurality of sub-pixel rows, but not limited thereto. The sub-pixels may include a plurality of red sub-pixels SPR, a plurality of blue sub-pixels SPB and a plurality of green sub-pixels SPG, but not limited thereto. In one of the sub-pixel rows extended along the second direction DT2, a green sub-pixel SPG may be disposed between a red sub-pixel SPR and a blue sub-pixel SPB, a blue sub-pixel SPB may be disposed between a green sub-pixel SPG and a red sub-pixel SPR, and a red sub-pixel SPR may be disposed between a blue sub-pixel SPB and a green sub-pixel SPG, but not limited thereto. In a sub-pixel row, the arrangement order of the sub-pixels along the second direction DT2 may sequentially be a red sub-pixel SPR, a green sub-pixel SPG, a blue sub-pixel SPB, a red sub-pixel SPR . . . , but not limited thereto.

In addition, the plurality of red sub-pixels SPR may be arranged along the first direction DT1 to form a plurality of red sub-pixel columns, the plurality of blue sub-pixels SPB may be arranged along the first direction DT1 to form a plurality of blue sub-pixel columns, and the plurality of green sub-pixels SPG may be arranged along the first direction DT1 to form a plurality of green sub-pixel columns, but not limited thereto.

The display panel 10 may include a plurality of data lines arranged side by side along the second direction DT2 and extended along the first direction DT1, and one of the data lines may be disposed between adjacent two of the sub-pixel columns, but not limited thereto. Taking the data line DLa shown in FIG. 2 as an example, the data line DLa may be disposed between a green sub-pixel column and a blue sub-pixel column, but not limited thereto. The data line DLa may also be disposed between adjacent two of the sub-pixel columns with other colors.

The data line DLa may be electrically connected to a second sub-pixel (such as the red sub-pixel SPR) adjacent to the data line DLa and located at a side (such as the right side) of the data line DLa in a m^{th} sub-pixel row (such as the sub-pixel row RW1 shown in FIG. 2). In addition, the data line DLa may be electrically connected to a first sub-pixel (such as the green sub-pixel SPG) adjacent to the data line DLa and located at another side (such as the left side) of the data line DLa in the m^{th} sub-pixel row (such as the sub-pixel row RW1). For example, m is equal to 1+4k (m=1+4k), k is an integer greater than or equal to 0, and m is a positive integer greater than or equal to 1. That is, m may be 1, 5, 9 . . . , and the condition that k is equal to 0 and m is equal to 1 is taken as an example here.

The data line DLa may be electrically connected to a first sub-pixel (such as the blue sub-pixel SPB) adjacent to the data line DLa and located at the right side of the data line DLa in a (m+1)^{th} sub-pixel row (such as the sub-pixel row RW2 shown in FIG. 2). In addition, the data line DLa may be electrically connected to a second sub-pixel (such as the red sub-pixel SPR) adjacent to the data line DLa and located at the left side of the data line DLa in the (m+1)^{th} sub-pixel row (such as the sub-pixel row RW2).

The data line DLa may be electrically connected to a second sub-pixel (such as the red sub-pixel SPR) adjacent to the data line DLa and located at the right side of the data line DLa in a (m+2)^{th} sub-pixel row (such as the sub-pixel row RW3 shown in FIG. 2). In addition, the data line DLa may be electrically connected to a first sub-pixel (such as the green sub-pixel SPG) adjacent to the data line DLa and located at the left side of the data line DLa in the (m+2)^{th} sub-pixel row (such as the sub-pixel row RW3).

The data line DLa may be electrically connected to a first sub-pixel (such as the blue sub-pixel SPB) adjacent to the data line DLa and located at the right side of the data line DLa in a (m+3)^{th} sub-pixel row (such as the sub-pixel row RW4 shown in FIG. 2). In addition, the data line DLa may be electrically connected to a second sub-pixel (such as the red sub-pixel SPR) adjacent to the data line DLa and located at the left side of the data line DLa in the (m+3)^{th} sub-pixel row (such as the sub-pixel row RW4). The colors of the sub-pixels electrically connected to the data line DLa mentioned above is only an example, and the colors of the sub-pixels electrically connected to the data lines may be different according to different data lines.

In addition, taking the data line DLb located at the right side of the data line DLa shown in FIG. 2 as an example, the data line DLb may be disposed between a red sub-pixel column and a green sub-pixel column, but not limited thereto. The data line DLb may be disposed between adjacent two of the sub-pixel columns with other colors, such as another data line DLb located at the left side of the data line DLa shown in FIG. 2.

The data line DLb may be electrically connected to a first sub-pixel (such as the green sub-pixel SPG) adjacent to the data line DLb and located at the right side of the data line DLb in a m^{th} sub-pixel row (such as the sub-pixel row RW1). In addition, the data line DLb may be electrically connected to a second sub-pixel (such as the blue sub-pixel SPB) adjacent to the data line DLb and located at the left side of the data line DLb in the sub-pixel row RW1.

The data line DLb may be electrically connected to a second sub-pixel (not shown) adjacent to the data line DLb and located at the right side of the data line DLb in a (m+1)^{th} sub-pixel row (such as the sub-pixel row RW2). In addition, the data line DLb may be electrically connected to a first sub-pixel (such as the red sub-pixel SPR) adjacent to the data line DLb and located at the left side of the data line DLb in the sub-pixel row RW2.

The data line DLb may be electrically connected to a first sub-pixel (such as the green sub-pixel SPG) adjacent to the data line DLb and located at the right side of the data line DLb in a (m+2)^{th} sub-pixel row (such as the sub-pixel row RW3). In addition, the data line DLb may be electrically connected to a second sub-pixel (such as the blue sub-pixel SPB) adjacent to the data line DLb and located at the left side of the data line DLb in the sub-pixel row RW3.

The data line DLb may be electrically connected to a second sub-pixel (not shown) adjacent to the data line DLb and located at the right side of the data line DLb in a (m+3)^{th} sub-pixel row (such as the sub-pixel row RW4). In addition, the data line DLb may be electrically connected to a first sub-pixel (such as the red sub-pixel SPR) adjacent to the data line DLb and located at the left side of the data line DLb in the sub-pixel row RW4. The colors of the sub-pixels electrically connected to the data line DLb mentioned above is only an example, and the colors of the sub-pixels electrically connected to the data lines may be different according to different data lines, such as the data line DLb located at the left side of the data line DLa shown in FIG. 2.

The data lines may include a plurality of data lines DLa and a plurality of data lines DLb, and the data lines DLa and the data lines DLb may be alternately arranged in the second direction DT2. For example, the arrangement order of the data lines in the second direction DT2 may sequentially be a data line DLa, a data line DLb, a data line DLa, a data line DLb . . . , but not limited thereto. The connection method of each of the data lines DLa and the sub-pixels and the connection method of each of the data lines DLb and the sub-pixels may refer to the above-mentioned descriptions.

In this embodiment, two sub-pixel columns are disposed between adjacent two of the data lines (such as the data line DLa and the data line DLb). In the conventional display panel, each of the sub-pixel columns is configured with a data line, such that only one sub-pixel column is disposed between adjacent two of the data lines. Therefore, the number of data lines in the display panel 10 of this embodiment can be greatly reduced compared with the conventional display panel. Accordingly, the number of the signal lines used for electrically connecting the data lines and the integrated circuit 104 in the peripheral region PR may be reduced as well, thereby reducing the required area of the signal lines in the peripheral region PR and reducing the frame width of the display panel 10.

As shown in FIG. 2, a g^{th} gate line (such as the gate line GL1) may be electrically connected to a second sub-pixel adjacent to the data line DLa and located at the right side of the data line DLa in the m^{th} sub-pixel row (such as the sub-pixel row RW1). Taking the data line DLb located at the right side of the data line DLa shown in FIG. 2 as an example, the gate line GL1 may be electrically connected to a first sub-pixel adjacent to the data line DLb and located at the right side of the data line DLb in the sub-pixel row RW1. For example, g is equal to 1+8h (g=1+8h), h is an integer greater than or equal to 0, and g is a positive integer greater than or equal to 1. That is, g may be 1, 9, 17 . . . , and the condition that h is 0 and g is 1 is taken as an example here.

A (g+1)^{th} gate line (such as the gate line GL2) may be electrically connected to a first sub-pixel adjacent to the data line DLa and located at the left side of the data line DLa in the m^{th} sub-pixel row (such as the sub-pixel row RW1). Taking the data line DLb located at the right side of the data line DLa shown in FIG. 2 as an example, the gate line GL2 may be electrically connected to a second sub-pixel adjacent to the data line DLb and located at the left side of the data line DLb in the sub-pixel row RW1.

A (g+2)^{th} gate line (such as the gate line GL3) may be electrically connected to a first sub-pixel adjacent to the data line DLa and located at the right side of the data line DLa in the (m+1)^{th} sub-pixel row (such as the sub-pixel row RW2). Taking the data line DLb located at the right side of the data line DLa shown in FIG. 2 as an example, the gate line GL3 may be electrically connected to a second sub-pixel (not shown) adjacent to the data line DLb and located at the right side of the data line DLb in the sub-pixel row RW2.

A (g+3)^{th} gate line (such as the gate line GL4) may be electrically connected to a second sub-pixel adjacent to the data line DLa and located at the left side of the data line DLa in the (m+1)^{th} sub-pixel row (such as the sub-pixel row RW2). Taking the data line DLb located at the right side of the data line DLa shown in FIG. 2 as an example, the gate line GL4 may be electrically connected to a first sub-pixel adjacent to the data line DLb and located at the left side of the data line DLb in the sub-pixel row RW2.

A (g+4)^{th} gate line (such as the gate line GL5) may be electrically connected to a second sub-pixel adjacent to the data line DLa and located at the right side of the data line DLa in the (m+2)^{th} sub-pixel row (such as the sub-pixel row RW3). Taking the data line DLb located at the right side of the data line DLa shown in FIG. 2 as an example, the gate line GL5 may be electrically connected to a first sub-pixel adjacent to the data line DLb and located at the right side of the data line DLb in the sub-pixel row RW3.

A (g+5)^{th} gate line (such as the gate line GL6) may be electrically connected to a first sub-pixel adjacent to the data line DLa and located at the left side of the data line DLa in the (m+2)^{th} sub-pixel row (such as the sub-pixel row RW3). Taking the data line DLb located at the right side of the data line DLa shown in FIG. 2 as an example, the gate line GL6 may be electrically connected to a second sub-pixel adjacent to the data line DLb and located at the left side of the data line DLb in the sub-pixel row RW3.

A (g+6)^{th} gate line (such as the gate line GL7) may be electrically connected to a first sub-pixel adjacent to the data line DLa and located at the right side of the data line DLa in the (m+3)^{th} sub-pixel row (such as the sub-pixel row RW4). Taking the data line DLb located at the right side of the data line DLa shown in FIG. 2 as an example, the gate line GL7 may be electrically connected to a second sub-pixel (not shown) adjacent to the data line DLb and located at the right side of the data line DLb in the sub-pixel row RW4.

A (g+7)^{th} gate line (such as the gate line GL8) may be electrically connected to a second sub-pixel adjacent to the data line DLa and located at the left side of the data line DLa in the (m+3)^{th} sub-pixel row (such as the sub-pixel row RW4). Taking the data line DLb located at the right side of the data line DLa shown in FIG. 2 as an example, the gate line GL8 may be electrically connected to a first sub-pixel adjacent to the data line DLb and located at the left side of the data line DLb in the sub-pixel row RW4.

In this embodiment, two gate lines (such as the gate line GL2 and the gate line GL3) may be disposed between adjacent two of the sub-pixel rows (such as the sub-pixel row RW1 and the sub-pixel row RW2), but not limited thereto. In addition, the pixel structures in the region Rg mentioned above may be applied to other regions in the display region DR.

In this embodiment, the gate driver circuit 1021 and the gate driver circuit 1022 shown in FIG. 1 can output a plurality of scan signals to the gate lines GL (such as the gate lines GL1 to GL8 shown in FIG. 2) in a plurality of frames to drive the sub-pixels in the display region DR. For example, the gate driver circuit 1022 may be used to output scan signals to the gate lines GL1, GL3, GL5 and GL7, and the gate driver circuit 1021 may be used to output scan signals to the gate lines GL2, GL4, GL6 and GL8, but not limited thereto. In some embodiments, the gate driver circuit 1021 may be used to output scan signals to the gate lines GL1, GL3, GL5 and GL7, and the gate driver circuit 1022 may be used to output scan signals to the gate lines GL2, GL4, GL6 and GL8, but not limited thereto.

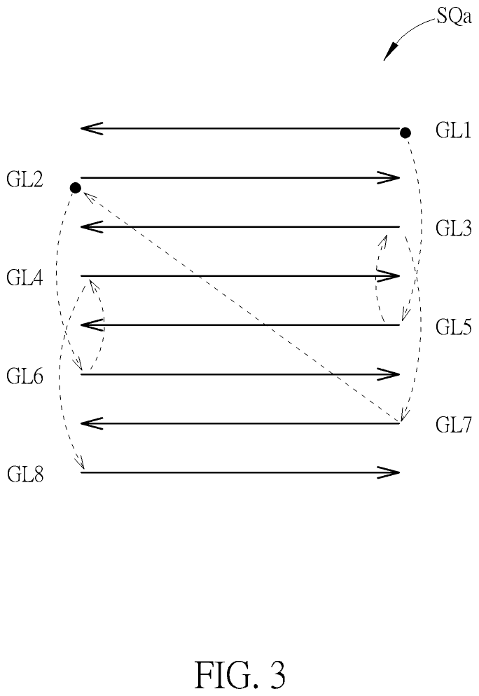

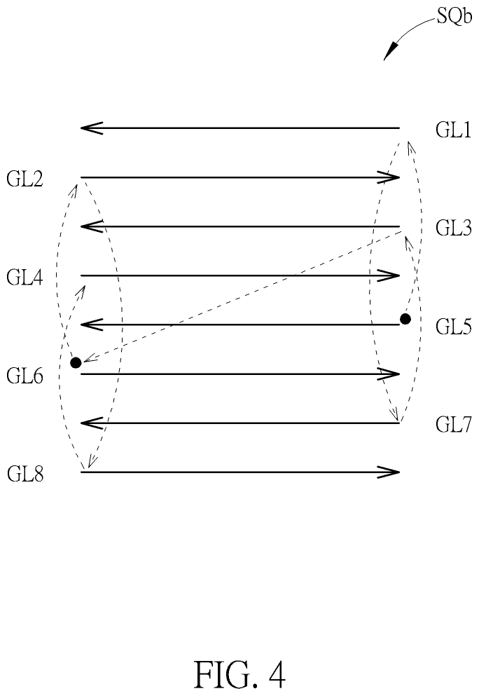

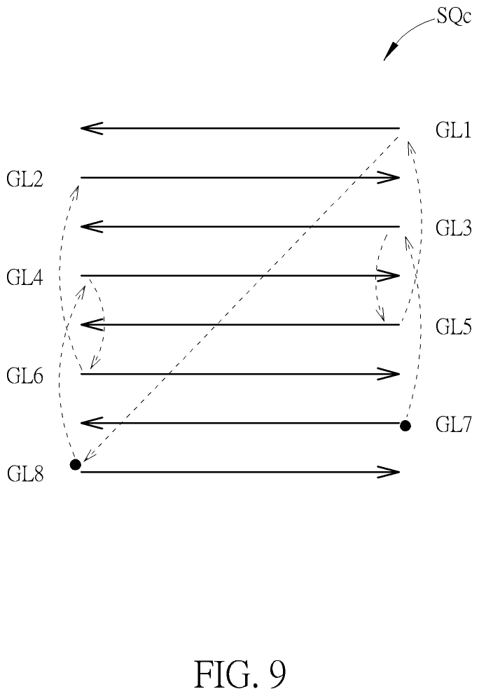

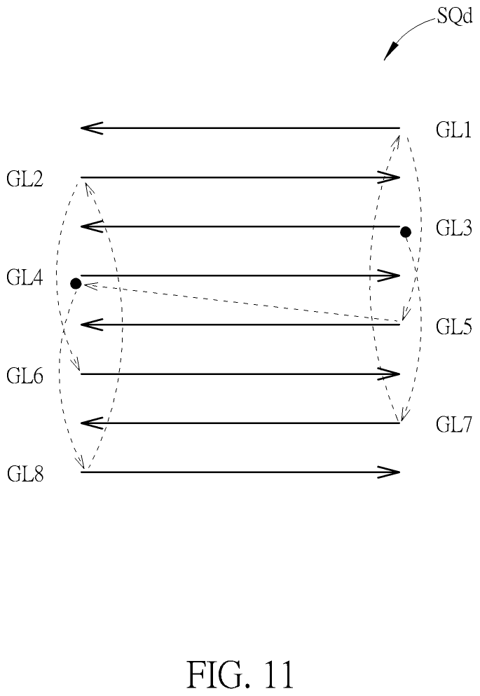

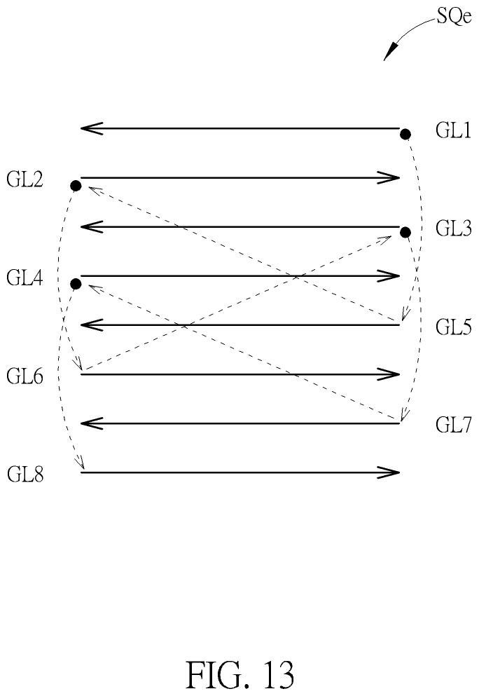

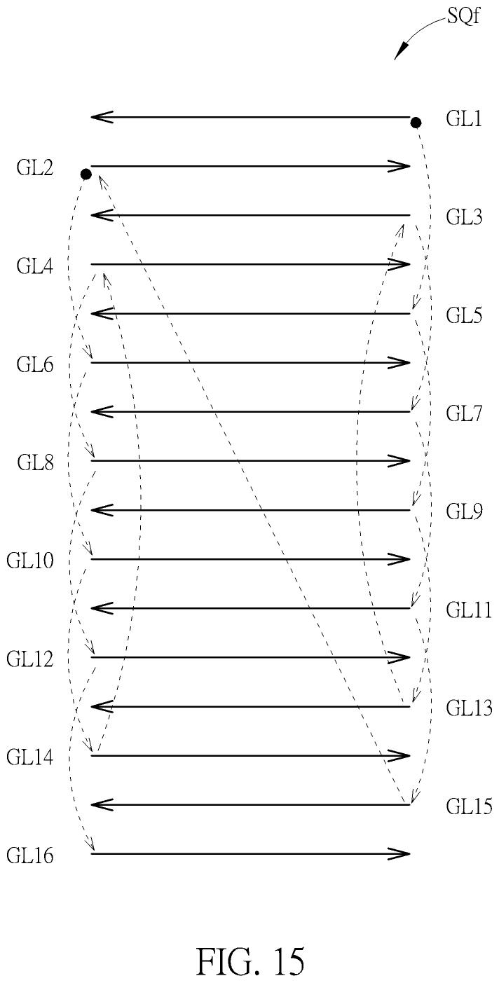

In this embodiment, the gate driver circuit 1021 and the gate driver circuit 1022 can output the scan signals to the corresponding gate lines in a multihop manner, but not limited thereto. Referring to FIG. 2 and FIG. 3, FIG. 3 schematically illustrates a scan order of a gate driver circuit in a frame according to the first embodiment of the present invention. The different directions of the arrows of the gate lines GL1, GL3, GL5, GL7 and the gate lines GL2, GL4, GL6, GL8 shown in FIG. 3 (and the following FIG. 4, FIG. 9, FIG. 11, FIG. 13 and FIG. 15) represents that the scan signals of the gate lines GL1, GL3, GL5, GL7 and the scan signals of the gate lines GL2, GL4, GL6, GL8 may be provided by different gate driver circuits (such as the gate driver circuit 1021 and the gate driver circuit 1022). As shown in FIG. 3, the gate driver circuit 1021 and the gate driver circuit 1022 may output the scan signals to the corresponding gate lines according to a scan order SQa in the multihop manner in a frame. The scan order SQa may include an order of the gate driver circuits scanning from the g^{th} gate line (such as the gate line GL1), the (g+4)^{th} gate line (such as the gate line GL5), the (g+2)^{th} gate line (such as the gate line GL3), the (g+6)^{th} gate line (such as the gate line GL7), the (g+1)^{th} gate line (such as the gate line GL2), the (g+5)^{th} gate line (such as the gate line GL6), the (g+3)^{th} gate line (such as the gate line GL4) to the (g+7)^{th} gate line (such as the gate line GL8).

Taking the data line DLa shown in FIG. 2 as an example, when the gate driver circuit 1022 outputs the scan signal to the gate line GL1 and turn on a switch component SW of a second sub-pixel (such as the red sub-pixel SPR) located at the right side of the data line DLa in the sub-pixel row RW1, the data line DLa may output the gray level signal of red light to the switch component SW of the second sub-pixel located at the right side of the data line DLa in the sub-pixel row RW1.

Then, when the gate driver circuit 1022 outputs the scan signal to the gate line GL5 and turn on a switch component SW of a second sub-pixel (such as the red sub-pixel SPR) located at the right side of the data line DLa in the sub-pixel row RW3, the data line DLa may output the gray level signal of red light to the switch component SW of the second sub-pixel located at the right side of the data line DLa in the sub-pixel row RW3.

Then, when the gate driver circuit 1022 outputs the scan signal to the gate line GL3 and turn on a switch component SW of a first sub-pixel (such as the blue sub-pixel SPB) located at the right side of the data line DLa in the sub-pixel row RW2, the data line DLa may output the gray level signal of blue light to the switch component SW of the first sub-pixel located at the right side of the data line DLa in the sub-pixel row RW2.

Then, when the gate driver circuit 1022 outputs the scan signal to the gate line GL7 and turn on a switch component SW of a first sub-pixel (such as the blue sub-pixel SPB) located at the right side of the data line DLa in the sub-pixel row RW4, the data line DLa may output the gray level signal of blue light to the switch component SW of the first sub-pixel located at the right side of the data line DLa in the sub-pixel row RW4.

Then, when the gate driver circuit 1021 outputs the scan signal to the gate line GL2 and turn on a switch component SW of a first sub-pixel (such as the green sub-pixel SPG) located at the left side of the data line DLa in the sub-pixel row RW1, the data line DLa may output the gray level signal of green light to the switch component SW of the first sub-pixel located at the left side of the data line DLa in the sub-pixel row RW1.

Then, when the gate driver circuit 1021 outputs the scan signal to the gate line GL6 and turn on a switch component SW of a first sub-pixel (such as the green sub-pixel SPG) located at the left side of the data line DLa in the sub-pixel row RW3, the data line DLa may output the gray level signal of green light to the switch component SW of the first sub-pixel located at the left side of the data line DLa in the sub-pixel row RW3.

Then, when the gate driver circuit 1021 outputs the scan signal to the gate line GL4 and turn on a switch component SW of a second sub-pixel (such as the red sub-pixel SPR) located at the left side of the data line DLa in the sub-pixel row RW2, the data line DLa may output the gray level signal of red light to the switch component SW of the second sub-pixel located at the left side of the data line DLa in the sub-pixel row RW2.

Then, when the gate driver circuit 1021 outputs the scan signal to the gate line GL8 and turn on a switch component SW of a second sub-pixel (such as the red sub-pixel SPR) located at the left side of the data line DLa in the sub-pixel row RW4, the data line DLa may output the gray level signal of red light to the switch component SW of the second sub-pixel located at the left side of the data line DLa in the sub-pixel row RW4.

Therefore, when the gate driver circuit 1021 and the gate driver circuit 1022 output the scan signals to the corresponding gate lines according to the scan order SQa, the order that the data line DLa outputs the gray level signals of different colors is shown in the following table 1. The “R” in the table 1 represents red, the “B” in the table 1 represents blue, and the “G” in the table 1 represents green. The first row of the table 1 from left to right shows the scan order SQa of outputting the scan signals to the gate lines, the “R”, “G”, “B” shown in the second row of the table 1 represent the gray level signals of different colors output by the data line DLa to each of the corresponding gate lines, and the “R”, “G”, “B” shown in the first column of the table 1 represent the images of different pure colors displayed by the display panel 10. In addition, when the value is 1 in the cell, it represents that the data line DLa outputs the gray level signals of the color corresponding to “R”, “G”, or “B”, and when value is 0 in the cell, it represents that the data line DLa does not output the gray level signal of the color corresponding to “R”, “G”, or “B”.

TABLE 1

| SQa | GL1 | GL5 | GL3 | GL7 | GL2 | GL6 | GL4 | GL8 |
|---|---|---|---|---|---|---|---|---|
| DLa | R | R | B | B | G | G | R | R |
| R | 1 | 1 | 0 | 0 | 0 | 0 | 1 | 1 |
| G | 0 | 0 | 0 | 0 | 1 | 1 | 0 | 0 |
| B | 0 | 0 | 1 | 1 | 0 | 0 | 0 | 0 |

In addition, when the gate driver circuit 1021 and the gate driver circuit 1022 output the scan signals to the corresponding gate lines according to an order scanning from the gate line GL1, the gate line GL2 . . . to the gate line GL8 in the conventional manner, the order that the data line DLa outputs the gray level signals of different colors may be shown in table 2.

TABLE 2

| | GL1 | GL2 | GL3 | GL4 | GL5 | GL6 | GL7 | GL8 |
|---|---|---|---|---|---|---|---|---|
| DLa | R | G | B | R | R | G | B | R |
| R | 1 | 0 | 0 | 1 | 1 | 0 | 0 | 1 |
| G | 0 | 1 | 0 | 0 | 0 | 1 | 0 | 0 |
| B | 0 | 0 | 1 | 0 | 0 | 0 | 1 | 0 |

As shown in the table 1, in the case of displaying the images of pure red color in the period of driving from the gate line GL1 to the gate line GL8, and when the gate driver circuit 1022 continuously drives from the gate line GL1 and the gate line GL5, or when the gate driver circuit 1021 continuously drives the gate line GL4 and the gate line GL8, the data line DLa may continuously transmit the gray level signals of red light to two corresponding sub-pixels.

In the case of displaying the images of pure green color, and when the gate driver circuit 1021 continuously drives the gate line GL2 and the gate line GL6, the data line DLa may continuously transmit the gray level signals of green light to two corresponding sub-pixels.

In the case of displaying the images of pure blue color, and when the gate driver circuit 1022 continuously drives the gate line GL3 and the gate line GL7, the data line DLa may continuously transmit the gray level signals of blue light to two corresponding sub-pixels.

However, if the scan signals are output according to the order shown in the table 2, in the period of driving from the gate line GL1 to the gate line GL8 and in the case that only the images of pure red color are displayed, and when the gate driver circuit 1021 and the gate driver circuit 1022 continuously drive the gate line GL4 and the gate line GL5, the data line DLa may continuously transmit the gray level signals of red color to two corresponding sub-pixels. When the images of the pure green color or the pure blue color are displayed, the gray level signals of the same colors are not continuously transmitted to the corresponding sub-pixels.

In another aspect, in the case that the images of the pure color (such as green or blue) are displayed and when the scan signals are output according to the scan order SQa, the data line DLa only needs to be turned on and turned off once to transmit the gray level signal of green light or the gray level signal of blue light in the period of driving from the gate line GL1 to the gate line GL8. When the scan signals are output according to the scan order shown in the table 2, the data line DLa needs to be turned on and turned off twice to transmit the gray level signal of green light or the gray level signal of blue light in the period of driving from the gate line GL1 to the gate line GL8.

Therefore, the number of times that the data line DLa is turned on and turned off to transmit gray level signals may be reduced by adopting the scan order SQa. In addition, since the operations of turning on and off of transmitting the signals involves the conversion between a high voltage and a low voltage, the power consumption of the display panel 10 may be reduced by adopting the scan order SQa.

Referring to FIG. 4, FIG. 4 schematically illustrates a scan order of the gate driver circuit in another frame according to the first embodiment of the present invention. Ina frame, the gate driver circuit 1021 and the gate driver circuit 1022 may output the scan signals to the corresponding gate lines according to a scan order SQb in a multihop manner. The scan order SQb may include an order of the gate driver circuits scanning from the (g+4)^{th} gate line (such as the gate line GL5), the g^{th} gate line (such as the gate line GL1), the (g+6)^{th} gate line (such as the gate line GL7), the (g+2)^{th} gate line (such as the gate line GL3), the (g+5)^{th} gate line (such as the gate line GL6), the (g+1)^{th} gate line (such as the gate line GL2), the (g+7)^{th} gate line (such as the gate line GL8) to the (g+3)^{th} gate line (such as the gate line GL4).

Referring to FIG. 2 and FIG. 4, when the gate driver circuit 1021 and the gate driver circuit 1022 output the scan signals to the corresponding gate lines according to the scan order SQb, the order that the data line DLa outputs the gray level signals of different colors may be shown in the following table 3.

TABLE 3

| SQb | GL5 | GL1 | GL7 | GL3 | GL6 | GL2 | GL8 | GL4 |
|---|---|---|---|---|---|---|---|---|
| DLa | R | R | B | B | G | G | R | R |
| R | 1 | 1 | 0 | 0 | 0 | 0 | 1 | 1 |
| G | 0 | 0 | 0 | 0 | 1 | 1 | 0 | 0 |
| B | 0 | 0 | 1 | 1 | 0 | 0 | 0 | 0 |

From the comparison of the table 3 and the table 1, it can be seen that when the gate driver circuit 1021 and the gate driver circuit 1022 output the scan signals to the corresponding gate lines according to the scan order SQb, the number of times that the data line DLa are turned on and turned off to transmit gray level signals may be reduced, thereby reducing the power consumption of the display panel 10, which is the same as the advantage of adopting the scan order SQa.

In this embodiment, the display panel 10 may include a plurality of frames, and the scan orders (such as the order of outputting the scan signals to the gate lines) of the gate driver circuit 1021 and the gate driver circuit 1022 may be different in at least two continuous frames. In this embodiment, the plurality of frames may include at least one first frame and at least one second frame, and one of the first frames and one of the second frames may be two continuous frames. In this embodiment, a first scan order may be included in the first frame, and the scan order SQa shown in FIG. 3 may for example be the first scan order of the first frame, but not limited thereto. In this embodiment, a second scan order may be included in the second frame, and the scan order SQb shown in FIG. 4 may for example be the second scan order of the second frame, but not limited thereto.

In some embodiments, the scan order SQa shown in FIG. 3 may for example be the second scan order of the second frame, and the scan order SQb shown in FIG. 4 may for example be the first scan order of the first frame, but not limited thereto.

For example, referring to the table 1, in the case that the scan order SQa is adopted in the display panel 10 and the images of pure red color are displayed, and when the gate driving circuit 1021 finishes driving the gate line GL6 and starts to drive the gate line GL4, the gray level signals of red light output by the data line DLa have to be risen from a low electric potential to a high electric potential. However, since the scan time of each of the gate lines is short in the display panels with high resolution (such as 720*1560), the charging of the signals output by the data line DLa may be insufficient, thereby generating the horizontal stripe at the location corresponding to the gate line GL4 in the screen.

Similarly, referring to the table 3, in the case that the scan order SQb is adopted in the display panel 10 and the images of pure red color are displayed, and when the gate driving circuit 1021 finishes driving the gate line GL2 and starts to drive the gate line GL8, the gray level signals of red light output by the data line DLa have to be risen from a low electric potential to a high electric potential. However, due to insufficient charging of the signals output by the data line DLa, the horizontal stripe is generated at the location corresponding to the gate line GL8 in the screen. In addition, when the same scan order is adopted in the plurality of frames in the display panel 10, the users may easily detect the existence of the horizontal stripe because the location of the generated horizontal stripe is not changed.

In this embodiment, the scan orders of the gate driver circuits may be different from each other in at least two continuous frames. For example, the first frame may be a k^{th} frame in the plurality of frames, the second frame may be a (k+1)^{th} frame in the plurality of frames, and k is a positive integer greater than or equal to 1. In the continuous first frame and the second frame, the first frame may have the scan order SQa, and the second frame may have the scan order SQb. Therefore, the locations of the horizontal stripes caused by insufficient charging of the signal output by the data line DLa are different in different frames, such that it is difficult for users to perceive the existence of horizontal stripes, thereby improving the quality of display.

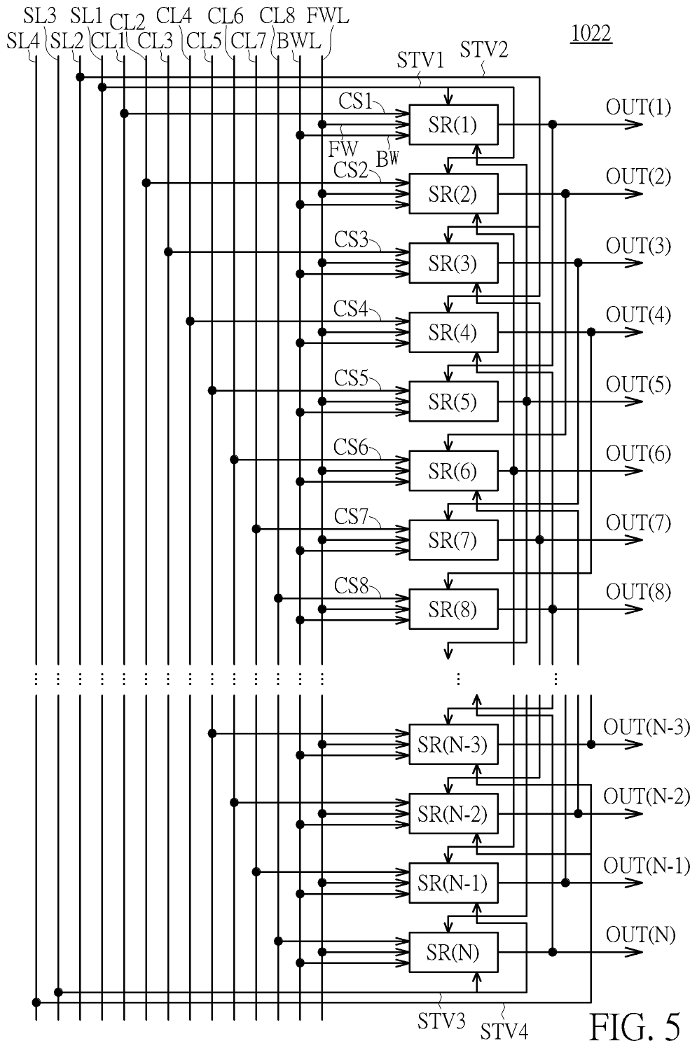

In another example, when each of the gate driver circuits includes P clock signal lines, the scan orders of the gate driver circuits may be different from each other in two continuous frames in P frames. For example, when the gate driver circuit 1022 includes eight clock signal lines (as shown in FIG. 5), P may equal to eight. Therefore, the scan orders of the gate driver circuits may be different from each other in two continuous frames in eight frames, but not limited thereto.

In some embodiments, the display panel 10 may include a plurality of first frames and a plurality of second frames, and the first frames and the second frames may be alternately arranged. For example, the gate driver circuits may scan the gate lines GL according to the scan order SQa, the scan order SQb, the scan order SQa, the scan order SQb . . . sequentially in the plurality of frames, but not limited thereto. In some embodiments, at least two first frames may be performed continuously at first, and then at least two second frames may be performed continuously in the display panel 10. For example, the gate driver circuits may scan the gate lines GL according to the scan order SQa, the scan order SQa, the scan order SQb, the scan order SQb, the scan order SQa, the scan order SQa . . . sequentially in the plurality of frames, but not limited thereto. In some embodiments, three or more than three different scan orders may be adopted in the display panel 10, but not limited thereto.

The gate driver circuit 102 will be introduced in detail in the following description. Referring to FIG. 5, FIG. 5 schematically illustrates a gate driver circuit according to the first embodiment of the present invention. The gate driver circuit 1021 and the gate driver circuit 1022 may include the same structure in this embodiment, but not limited thereto. Taking the gate driver circuit 1022 as an example, the gate driver circuit 1022 of this embodiment may include clock signal lines CL1 to CL8, a first control signal line STL1, a second control signal line STL2, a third control signal line STL3, a fourth control signal line STL4, a forward input signal line FWL, a backward input signal line BWL and a first-level shift register SR(1) to a n^{th}-level shift register SR(N), wherein N is a positive integer greater than or equal to 9, but not limited thereto. The clock signal lines CL1 to CL8 provide the clock signals CS1-CS8 to the corresponding shift registers SR(1)-SR(N). The number of the clock signal lines is not limited to 8 in this invention. The first-level shift register SR(1) to the n^{th}-level shift register SR(N) may be the gate driver on array circuit structure.

The forward input signal line FWL and the backward input signal line BWL respectively provide a forward input signal FW and a backward input signal BW to the first-level shift register SR(1) to the n^{th}-level shift register SR(N). The first control signal line STL1 provides the first control signal STV1 to the first-level shift register SR(1) and the second-level shift register SR(2), the second control signal line STL2 provides the second control signal STV2 to the third-level shift register SR(3) and the fourth-level shift register SR(4), the third control signal line STL3 provides the third control signal STV3 to the N^{th}-level shift register SR(N) and the (N−1)^{th}-level shift register SR(N−1), the fourth control signal line STL4 provides the fourth control signal STV4 to the (N−2)^{th}-level shift register SR(N−2) and the (N−3)^{th}-level shift register SR(N−3). The first control signal STV1 and the second control signal STV2 may be used as an initial signal, and the third control signal STV3 and the fourth control signal STV4 may be used as an ending signal, but not limited thereto. The first control signal STV1 may be the same as the second control signal STV2, and the third control signal STV3 may be the same as the fourth control signal STV4, but not limited thereto.

The clock signal lines CL1 to CL8, the first control signal line STL1, the second control signal line STL2, the third control signal line STL3, the fourth control signal line STL4, the forward input signal line FWL and the backward input signal line BWL may be coupled to one or more than one chip. Therefore, the clock signals CS1 to CS8, the first control signal STV1, the second control signal STV2, the third control signal STV3, the fourth control signal STV4, the forward input signal FW and the backward input signal BW may be provided by the one or more than one chip, such as a driving chip and/or a timing control chip and so on, but not limited thereto.

In addition, each of the shift registers may be electrically connected to one of the gate lines GL, the first-level shift register SR(1) to the N^{th}-level shift register SR(N) may respectively generate a first-level scan signal OUT(1) to a N^{th}-level scan signal OUT(N), and the first-level scan signal OUT(1) to the N^{th}-level scan signal OUT(N) may respectively be output to the gate lines GL electrically connected to the gate driver circuit 1022. For example, in the gate driver circuit 1022, the first-level scan signal OUT(1) may be output to the gate line GL1, the second-level scan signal OUT(2) may be output to the gate line GL3, the third-level scan signal OUT(3) may be output to the gate line GL5, and the fourth-level scan signal OUT(4) may be output to the gate line GL7, and so on.

In another aspect, a first-level shift register to a N^{th}-level shift register (not shown) of the gate driver circuit 1021 may respectively generate a first-level scan signal to a N^{th}-level scan signal, and the scan signals may respectively be output to the gate lines GL electrically connected to the gate driver circuit 1021. For example, the first-level scan signal may be output to the gate line GL2, the second-level scan signal may be output to the gate line GL4, the third-level scan signal may be output to the gate line GL6, and the fourth-level scan signal may be output to the gate line GL8, and so on.

The gate driver circuit 1021 and the gate driver circuit 1022 of this embodiment may be applied to forward scan driving, but not limited thereto. In other embodiments, the gate driver circuit 1021 and the gate driver circuit 1022 may also be applied to backward scan driving.

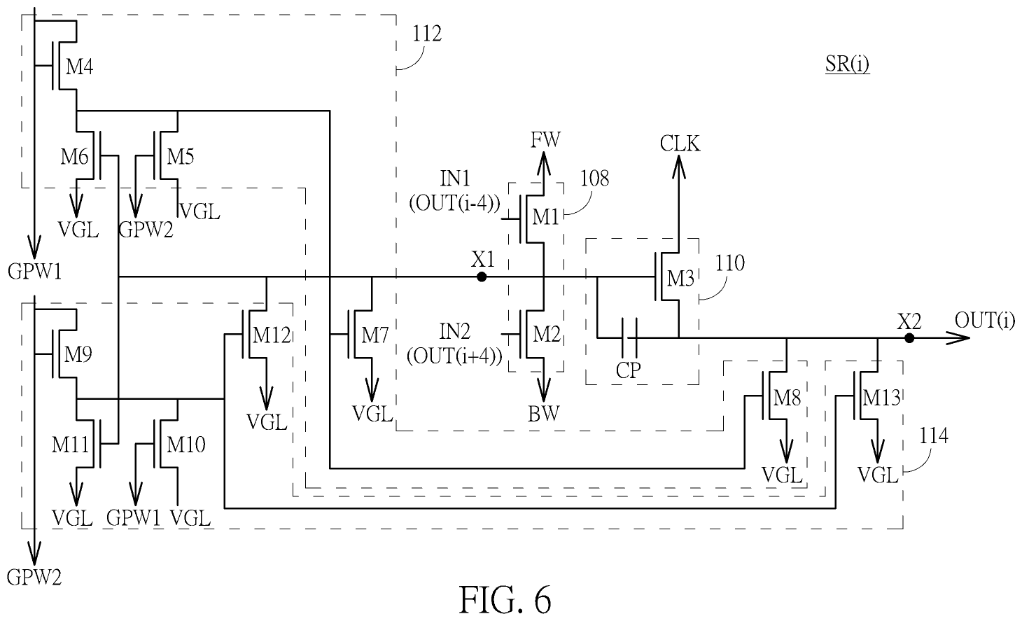

Referring to FIG. 6, FIG. 6 schematically illustrates an equivalent circuit diagram of an i^{th}-level shift register of the gate driver circuit shown in FIG. 5. The i^{th}-level (wherein i is a positive integer from 1 to N) shift register SR(i) includes a precharge unit 108 and a pull-up unit 110, wherein one terminal of the precharge unit 108 and one terminal of the pull-up unit 110 are coupled to a node X1, and another terminal of the pull-up unit 110 is coupled to a node X2. The pull-up unit 110 may output the i^{th}-level scan signal OUT(i) to the node X2, and the node X2 is electrically connected to the corresponding gate line GL, such that the pull-up unit 110 may output the i^{th}-level scan signal OUT(i) to drive the corresponding gate line GL.

The precharge unit 108 receives an input signal IN1 and an input signal IN2, and the precharge unit 108 outputs a precharge signal to the node X1 according to the input signal IN1 and the input signal IN2. The precharge unit 108 includes a transistor M1 and a transistor M2. The control terminal of the transistor M1 receives the input signal IN1, a first terminal of the transistor M1 receives the forward input signal FW, and the second terminal of the transistor M1 is coupled to the node X1. A control terminal of the transistor M2 receives the input signal IN2, the first terminal of the transistor M2 receives the backward input signal BW, the second terminal of the transistor M2 is coupled to the second terminal of the transistor M1, and the forward input signal FW and the backward input signal BW are opposite to each other during the display period of the display panel. For example, when one of the forward input signal FW and the backward input signal BW has high electric potential, another one of the forward input signal FW and the backward input signal BW has a low electric potential. In addition, in an embodiment that the gate driver circuit 102 is single-direction scanning, the first terminal of the transistor M1 receives a high electric potential, and the first terminal of the transistor M2 receives a low electric potential. In addition, the forward input signal line FWL and the backward input signal line BWL shown in FIG. 5 may respectively be a high electric potential line and a low electric potential line. The rest is similar to the above-mentioned description.

For example, the high electric potential may be a gate high voltage (VGH), and the low electric potential may be a gate low voltage (VGL). In this specification, the transistor may for example be the thin film transistor, and the “control terminal”, the “first terminal” and the “second terminal” of the transistor may respectively be the gate, the source and the drain of the transistor or the gate, the drain and the source of the transistor.

As shown in FIG. 5 and FIG. 6, if the shift register SR(i) is the first-level shift register or the second-level shift register (that is, i is 1 or 2), the input signal IN1 is the first control signal STV1, and the input signal IN2 is the scan signal OUT(i+4) output by the (i+4)^{th}-level shift register SR(i+4) (that is, the fifth-level scan signal OUT(5) or the sixth-level scan signal OUT(6)). If the shift register SR(i) is the third-level shift register or the fourth-level shift register (that is, i is 3 or 4), the input signal IN1 is the second control signal STV2, and the input signal IN2 is the scan signal OUT(i+4) output by the (i+4)^{th}-level shift register SR(i+4) (that is, the seventh-level scan signal OUT(7) or the eighth-level scan signal OUT(8)).

If the shift register SR(i) is any one of the fifth-level shift register to the (N−4)^{th}-level shift register (that is, i is any one of the positive integer from 5 to N−4), the input signal IN1 and the input signal IN2 may respectively be the (i−4)^{th}-level scan signal OUT(i−4) output by the (i−4)^{th}-level shift register SR(i−4) and the (i+4)^{th}-level scan signal OUT(i+4) output by the (i+4)^{th}-level shift register SR(i+4). Therefore, in this embodiment, the i^{th}-level shift register SR(i) is electrically connected to the (i−4)^{th}-level shift register SR(i−4) and the (i+4)^{th}-level shift register SR(i+4), wherein i is a positive integer greater than or equal to 5 and less than or equal to (N−4).

If the shift register SR(i) is the (N−3)^{th}-level shift register or the (N−2)^{th}-level shift register (that is, i is N−3 or N−2), the input signal IN1 is the scan signal OUT(i−4) output by the (i−4)^{th}-level shift register SR(i−4) (that is, the (N−7)^{th} scan signal OUT(N−7) or the (N−6)^{th} scan signal OUT(N−6)), and the input signal IN2 is the fourth control signal STV4. If the shift register SR(i) is the (N−1)^{th}-level shift register or the N^{th}-level shift register (that is, i is N−1 or N), the input signal IN1 is the scan signal OUT(i−4) output by the (i−4)^{th}-level shift register SR(i−4) (that is, the (N−5)^{th} scan signal OUT(N−5) or the (N−4)^{th} scan signal OUT(N−4)), and the input signal IN2 is the third control signal STV3.

It should be noted that when the gate driver circuit 1022 is in forward scanning, that is, when the forward input signal FW is in high electric potential and the backward input signal BW is in low electric potential, the first control signal STV1 and the second control signal STV2 may be the initial signal, and the third control signal STV3 and the fourth control signal STV4 may be the ending signal. When the gate driver circuit 1022 is in backward scanning, that is, when the forward input signal FW is in low electric potential and the backward input signal BW is in high electric potential, the third control signal STV3 and the fourth control signal STV4 may be the initial signal, and the first control signal STV1 and the second control signal STV2 may be the ending signal.

The pull-up unit 110 and the precharge unit 108 are coupled to the node X1, the pull-up unit 110 receives a clock signal CLK, and the scan signal OUT(i) is output by the node X2 according to the precharge signal of the node X1 and the clock signal CLK, wherein the clock signal CLK is any one of the clock signals CS1 to CS8. In the embodiment where N is a multiple of 8, if i is 1, 9 . . . , (N−7), then the clock signal CLK is the clock signal CS1; if i is 2, 10 . . . , (N−6), then the clock signal CLK is the clock signal CS2; if i is 3, 11 . . . , (N−5), then the clock signal CLK is the clock signal CS3; if i is 4, 12 . . . , (N−4), then the clock signal CLK is the clock signal CS4; if i is 5, 13 . . . , (N−3), then the clock signal CLK is the clock signal CS5; if i is 6, 14 . . . , (N−2), then the clock signal CLK is the clock signal CS6; if i is 7, 15 . . . , (N−1), then the clock signal CLK is the clock signal CS7; and if i is 8, 16 . . . , N, then the clock signal CLK is the clock signal CS8.

The pull-up unit 110 includes a transistor M3 and a capacitor CP. A gate of the transistor M3 is coupled to the node X1, a first terminal of the transistor M3 receives the clock signal CLK, and a second terminal of the transistor M3 is coupled to the node X2 and can output the scan signal OUT(i). The transistor M3 may be electrically connected to a gate line GL (shown in FIG. 1) of the display panel 10, and the transistor M3 may output the scan signal OUT(i) to the gate line GL. A first terminal of the capacitor CP is coupled to the node X1 and the gate of the transistor M3, and a second terminal of the capacitor CP is coupled to the node X2 and the second terminal of the transistor M3.

The i^{th}-level shift register SR(i) further includes a first pull-down unit 112 and a second pull-down unit 114, wherein one terminal of the precharge unit 108, one terminal of the pull-up unit 110, one terminal of the first pull-down unit 112 and one terminal of the second pull-down unit 114 are coupled to the node X1, and another terminal of the pull-up unit 110, another terminal of the first pull-down unit 112 and another terminal of the second pull-down unit 114 are coupled to the node X2. In addition, the gate driver circuit 1022 may further include a first pull-down control signal line and a second pull-down control signal line, and the first pull-down control signal line and the second pull-down control signal line may respectively provide a pull-down signal GPW1 and a pull-down signal GPW2 to each of the shift registers SR(1)-SR(N). The first pull-down unit 112 and the second pull-down unit 114 can control whether the scan signal OUT(i) is pulled down to and maintained at the reference electric potential according to the electric potential of the node X1 and the pull-down signals GPW1, GPW2. The pull-down signal GPW1 and the pull-down signal GPW2 may be opposite to each other during the frames. For example, one of the pull-down signal GPW1 and the pull-down signal GPW2 has high electric potential, and another one of the pull-down signal GPW1 and the pull-down signal GPW2 has low electric potential.

The first pull-down unit 112 includes transistors M4 to M8. The pull-down signal GPW1 is input to a control terminal and a first terminal of the transistor M4. The pull-down signal GPW2 is input to a control terminal of the transistor M5, a first terminal of the transistor M5 is coupled to a reference electric potential VGL, and a second terminal of the transistor M5 is coupled to a second terminal of the transistor M4. A control terminal of the transistor M6 is coupled to the node X1, a first terminal of the transistor M6 is coupled to the reference electric potential VGL, and a second terminal of the transistor M6 is coupled to the second terminal of the transistor M4. A control terminal of the transistor M7 is coupled to the second terminal of the transistor M6, a first terminal of the transistor M7 is coupled to the reference electric potential VGL, and a second terminal of the transistor M7 is coupled to the node X1. A control terminal of the transistor M8 is coupled to the second terminal of the transistor M6, a first terminal of the transistor M8 is coupled to the reference electric potential VGL, and a second terminal of the transistor M8 is coupled to the node X2.

After the shift register SR(i) outputs the scan signal OUT(i) to drive the corresponding pixel row, that is, the scan signal OUT(i) has risen to a high electric potential and maintained at the high electric potential for a period of time, then the scan signal OUT(i) has lowered to a low electric potential, and the node X1 has lowered from the high electric potential to the low electric potential, the first pull-down unit 112 starts to act. When the pull-down signal GPW1 has low electric potential and the pull-down signal GPW2 has high electric potential, the transistor M7 and the transistor M8 are turned off. In addition, when the pull-down signal GPW1 has high electric potential and the pull-down signal GPW2 has low electric potential, the transistor M7 and the transistor M8 are turned on, and the electric potential of the node X1 and the electric potential of the node X2 are set as the reference electric potential VGL. Therefore, the scan signal OUT(i) is maintained at low electric potential, such that the scan signal OUT(i) will not be interfered with noises.

The second pull-down unit 114 includes transistors M9 to M13. The pull-down signal GPW2 is input to a control terminal and a first terminal of the transistor M9. The pull-down signal GPW1 is input to a control terminal of the transistor M10, a first terminal of the transistor M10 is coupled to the reference electric potential VGL, and a second terminal of the transistor M10 is coupled to a second terminal of the transistor M9. A control terminal of the transistor M11 is coupled to the node X1, a first terminal of the transistor M11 is coupled to the reference electric potential VGL, and a second terminal of the transistor M11 is coupled to the second terminal of the transistor M9. A control terminal of the transistor M12 is coupled to the second terminal of the transistor M11, a first terminal of the transistor M12 is coupled to the reference electric potential VGL, and a second terminal of the transistor M12 is coupled to the node X1. A control terminal of the transistor M13 is coupled to the second terminal of the transistor M11, a first terminal of the transistor M13 is coupled to the reference electric potential VGL, and a second terminal of the transistor M13 is coupled to the node X2.

After the shift register SR(i) outputs the scan signal OUT(i) to drive the corresponding pixel row, that is, the scan signal OUT(i) has risen to a high electric potential and maintained at the high electric potential for a period of time, then the scan signal OUT(i) has lowered to a low electric potential, and the node X1 has lowered from the high electric potential to the low electric potential, the second pull-down unit 114 starts to act. When the pull-down signal GPW1 has low electric potential and the pull-down signal GPW2 has high electric potential, the transistor M12 and the transistor M13 are turned on, and the electric potential of the node X1 and the electric potential of the node X2 are set as the reference electric potential VGL. Therefore, the scan signal OUT(i) is maintained at low electric potential, such that the scan signal OUT(i) will not be interfered with noises. In addition, when the pull-down signal GPW1 has high electric potential and the pull-down signal GPW2 has low electric potential, the transistor M12 and the transistor M13 are turned off.

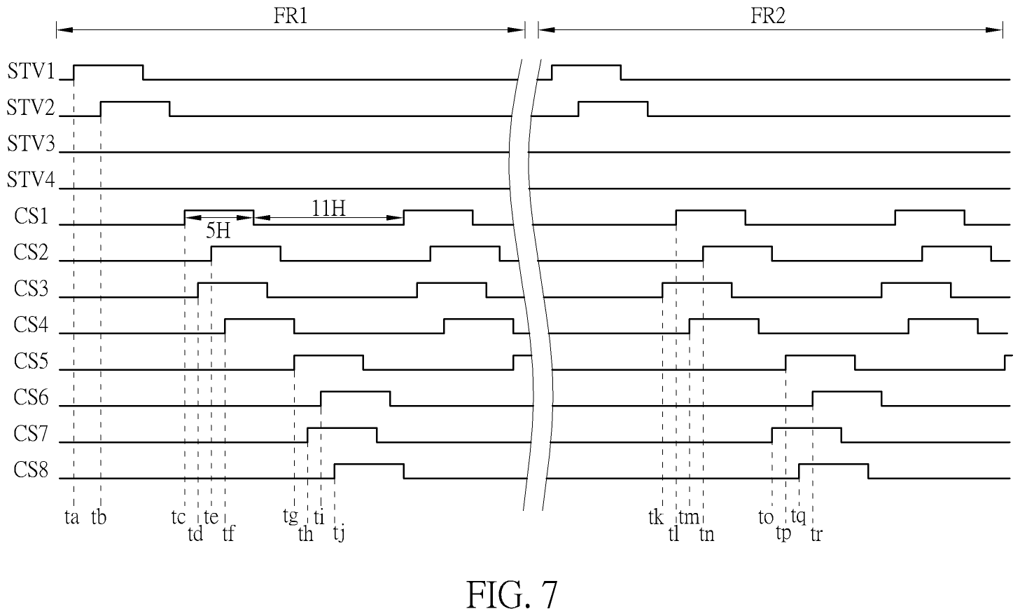

Referring to FIG. 3, FIG. 5, FIG. 6 and FIG. 7, FIG. 7 illustrates a timing diagram of the gate driver circuit shown in FIG. 5. For ease of explanation, only a portion of the first frame FR1 and a portion of the second frame FR2 are shown in FIG. 7, and the first frame FR1 and the second frame FR2 may be two continuous frames, but not limited thereto. The gate driver circuit 1022 is taken as an example in the following description. In the first frame FR1 shown in FIG. 7, the gate driver circuit 1022 scans the gate lines according to the scan order SQa, but not limited thereto.

When the first frame FR1 starts, the first control signal STV1 rises form low electric potential to high electric potential at time ta, and the transistors M1 of the first-level shift register SR(1) and the second-level shift register SR(2) are turned on due to the first control signal STV1. The second control signal STV2 rises from low electric potential to high electric potential at time tb, and the transistors M1 of the third-level shift register SR(3) and the fourth-level shift register SR(4) are turned on due to the second control signal STV2.

At time tc, the clock signal CS1 rises from low electric potential to high electric potential. At this time, the shift register SR(1) outputs the scan signal OUT(1) to the corresponding gate line GL1 according to the clock signal CS1. At time td, the clock signal CS3 rises from low electric potential to high electric potential. At this time, the shift register SR(3) outputs the scan signal OUT(3) to the corresponding gate line GL5 according to the clock signal CS3. At time te, the clock signal CS2 rises from low electric potential to high electric potential. At this time, the shift register SR(2) outputs the scan signal OUT(2) to the corresponding gate line GL3 according to the clock signal CS2. At time tf, the clock signal CS4 rises from low electric potential to high electric potential. At this time, the shift register SR(4) outputs the scan signal OUT(4) to the corresponding gate line GL7 according to the clock signal CS4.

FIG. 7 also shows waveforms of the clock signals CS5 to CS8 transmitted to the shift registers SR(5)-SR(8) in the gate driver circuit 1022, and the shift registers SR(5)-SR(8) in the gate driver circuit 1022 can be used to transmit scan signals to the gate lines GL9, GL11, GL13 and GL15. Although the gate lines GL9 to GL16 are not shown in FIG. 2, the connecting structures of the sub-pixels, the gate lines GL9 to GL16 and the data lines DLa, DLb may be the same as the connecting structures shown in FIG. 2.

At time tg, the clock signal CS5 rises from low electric potential to high electric potential. At this time, the shift register SR(5) outputs the scan signal OUT(5) to the corresponding gate line GL9 according to the clock signal CS5. At time th, the clock signal CS7 rises from low electric potential to high electric potential. At this time, the shift register SR(7) outputs the scan signal OUT(7) to the corresponding gate line GL13 according to the clock signal CS7. At time t₁, the clock signal CS6 rises from low electric potential to high electric potential. At this time, the shift register SR(6) outputs the scan signal OUT(6) to the corresponding gate line GL11 according to the clock signal CS6. At time tj, the clock signal CS8 rises from low electric potential to high electric potential. At this time, the shift register SR(8) outputs the scan signal OUT(8) to the corresponding gate line GL15 according to the clock signal CS8.

In addition, the gate driver circuit 1021 outputs the scan signals to the gate line GL2, the gate line GL6, the gate line GL4 and the gate line GL8 in sequence according to the scan order SQa between the time tf and the time tg.

Referring to FIG. 4 to FIG. 7, the gate driver circuit 1022 is taken as an example in the following description. In the second frame FR2 of FIG. 7, the gate driver circuit 1022 scans the gate lines according to the scan order SQb, but not limited thereto. The operations of the first control signal STV1 and the second control signal STV2 can be the same as the above-mentioned descriptions, and will not be redundantly described.

At time tk, the clock signal CS3 rises from low electric potential to high electric potential. At this time, the shift register SR(3) outputs the scan signal OUT(3) to the corresponding gate line GL5 according to the clock signal CS3. At time t1, the clock signal CS1 rises from low electric potential to high electric potential. At this time, the shift register SR(1) outputs the scan signal OUT(1) to the corresponding gate line GL1 according to the clock signal CS1. At time tm, the clock signal CS4 rises from low electric potential to high electric potential. At this time, the shift register SR(4) outputs the scan signal OUT(4) to the corresponding gate line GL7 according to the clock signal CS4. At time tn, the clock signal CS2 rises from low electric potential to high electric potential. At this time, the shift register SR(2) outputs the scan signal OUT(2) to the corresponding gate line GL3 according to the clock signal CS2.

At time to, the clock signal CS7 rises from low electric potential to high electric potential. At this time, the shift register SR(7) outputs the scan signal OUT(7) to the corresponding gate line GL13 according to the clock signal CS7. At time tp, the clock signal CS5 rises from low electric potential to high electric potential. At this time, the shift register SR(5) outputs the scan signal OUT(5) to the corresponding gate line GL9 according to the clock signal CS5. At time tq, the clock signal CS8 rises from low electric potential to high electric potential. At this time, the shift register SR(8) outputs the scan signal OUT(8) to the corresponding gate line GL15 according to the clock signal CS8. At time tr, the clock signal CS6 rises from low electric potential to high electric potential. At this time, the shift register SR(6) outputs the scan signal OUT(6) to the corresponding gate line GL11 according to the clock signal CS6.

In addition, the gate driver circuit 1021 outputs the scan signals to the gate line GL6, the gate line GL2, the gate line GL8 and the gate line GL4 in sequence according to the scan order SQb during the time tn to the time to.

In this embodiment, the time (or duration) that each of the clock signals has high electric potential can include five time units 5H. The time (or duration) that each of the clock signals has low electric potential and locates between adjacent two waveforms of high electric potentials may include eleven time units 11H. In the frames of this embodiment (such as the first frame FR1 or the second frame FR2), each of the clock signals may include a plurality of cycles, and the clock signal has high electric potential and low electric potential in each of the cycles. As shown in FIG. 7, in the first frame FR1 or the second frame FR2, the time duration of each of the cycles may include sixteen time units 16H, the time having high electric potential may include five time units 5H, the time having low electric potential may include eleven time units 11H, and the scan time of a gate line may include five time units 5H, but the time having high electric potential, the time having low electric potential and the scan time of the gate lines are not limited thereto. The length of each time unit H is not limited in this invention. In some embodiments, the duration that each of the clock signals has high electric potential may range from three time units 3H to eight time units 8H, but not limited thereto.

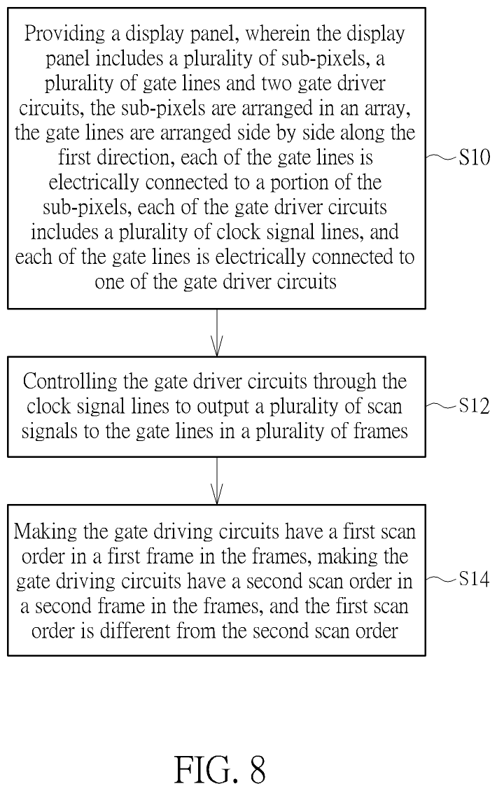

Referring to FIG. 8, FIG. 8 schematically illustrates a flow chart of a driving method of a display panel according to the first embodiment of the present invention. According to the above-mentioned descriptions, the driving method of the display panel 10 of this embodiment may include the following steps S10 to S14 shown in FIG. 8, and the driving method is not limited to the order of the steps shown in the following description.

S10: providing a display panel, wherein the display panel includes a plurality of sub-pixels, a plurality of gate lines and two gate driver circuits, the sub-pixels are arranged in an array, the gate lines are arranged side by side along the first direction, each of the gate lines is electrically connected to a portion of the sub-pixels, each of the gate driver circuits includes a plurality of clock signal lines, and each of the gate lines is electrically connected to one of the gate driver circuits;

S12: controlling the gate driver circuits through the clock signal lines to output a plurality of scan signals to the gate lines in a plurality of frames; and

S14: making the gate driving circuits have a first scan order in a first frame in the frames, making the gate driving circuits have a second scan order in a second frame in the frames, and the first scan order is different from the second scan order.

The driving method of the display panel of this invention is not limited to the above-mentioned embodiments. Other embodiments of this invention will be introduced in the following description. However, in order to simplify the description and highlight the differences between the embodiments, the same components would be labeled with the same symbol in the following description, and the repeated descriptions will not be redundantly described.

Referring to FIG. 9, FIG. 9 schematically illustrates a scan order of a gate driver circuit in a frame according to a second embodiment of the present invention. In a frame, the gate driver circuit 1021 and the gate driver circuit 1022 may output the scan signals to the corresponding gate lines according to a scan order SQc in a multihop manner. The scan order SQc may include an order of the gate driver circuits scanning from the (g+6)^{th} gate line (such as the gate line GL7), the (g+2)^{th} gate line (such as the gate line GL3), the (g+4)^{th} gate line (such as the gate line GL5), the g^{th} gate line (such as the gate line GL1), the (g+7)^{th} gate line (such as the gate line GL8), the (g+3)^{th} gate line (such as the gate line GL4), the (g+5)^{th} gate line (such as the gate line GL6) to the (g+1)^{th} gate line (such as the gate line GL2).

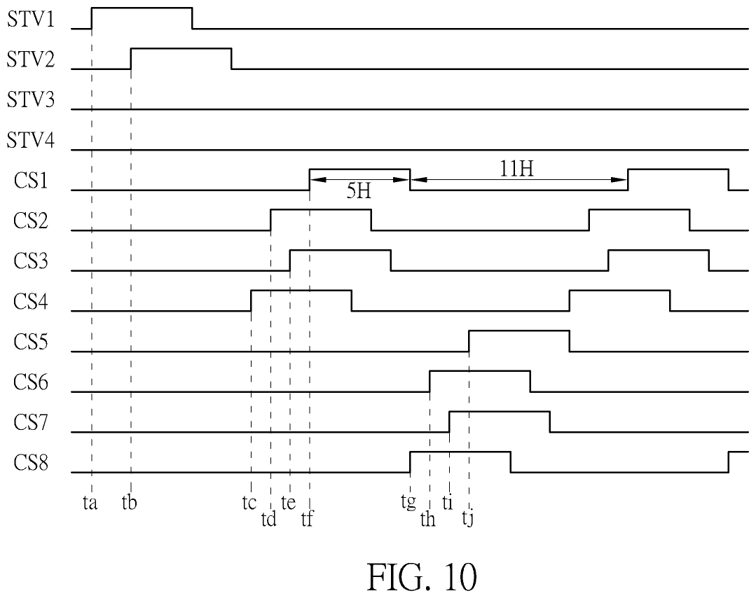

Referring to FIG. 10, FIG. 10 illustrates a timing diagram of a gate driver circuit according to the second embodiment of the present invention. For ease of explanation, FIG. 10 only shows a portion of a frame. The gate driver circuit 1022 is taken as an example in the following description. At time tc, the clock signal CS4 rises from low electric potential to high electric potential. At this time, the shift register SR(4) outputs the scan signal OUT(4) to the corresponding gate line GL7 according to the clock signal CS4. At time td, the clock signal CS2 rises from low electric potential to high electric potential. At this time, the shift register SR(2) outputs the scan signal OUT(2) to the corresponding gate line GL3 according to the clock signal CS2. At time te, the clock signal CS3 rises from low electric potential to high electric potential. At this time, the shift register SR(3) outputs the scan signal OUT(3) to the corresponding gate line GL5 according to the clock signal CS3. At time tf, the clock signal CS1 rises from low electric potential to high electric potential. At this time, the shift register SR(1) outputs the scan signal OUT(1) to the corresponding gate line GL1 according to the clock signal CS1.

At time tg, the clock signal CS8 rises from low electric potential to high electric potential. At this time, the shift register SR(8) outputs the scan signal OUT(8) to the corresponding gate line GL15 according to the clock signal CS8. At time th, the clock signal CS6 rises from low electric potential to high electric potential. At this time, the shift register SR(6) outputs the scan signal OUT(6) to the corresponding gate line GL11 according to the clock signal CS6. At time ti, the clock signal CS7 rises from low electric potential to high electric potential. At this time, the shift register SR(7) outputs the scan signal OUT(7) to the corresponding gate line GL13 according to the clock signal CS7. At time tj, the clock signal CS5 rises from low electric potential to high electric potential. At this time, the shift register SR(5) outputs the scan signal OUT(5) to the corresponding gate line GL9 according to the clock signal CS5.

In addition, the gate driver circuit 1021 outputs the scan signals to the gate line GL8, the gate line GL4, the gate line GL6 and the gate line GL2 in sequence according to the scan order SQc during the time tf to the time tg.

Referring to FIG. 11, FIG. 11 schematically illustrates a scan order of a gate driver circuit in a frame according to a third embodiment of the present invention. In a frame, the gate driver circuit 1021 and the gate driver circuit 1022 may output the scan signals to the corresponding gate lines according to a scan order SQd in a multihop manner. The scan order SQd may include an order of the gate driver circuits scanning from the (g+2)^{th} gate line (such as the gate line GL3), the (g+6)^{th} gate line (such as the gate line GL7), the g^{th} gate line (such as the gate line GL1), the (g+4)^{th} gate line (such as the gate line GL5), the (g+3)^{th} gate line (such as the gate line GL4), the (g+7)^{th} gate line (such as the gate line GL8), the (g+1)^{th} gate line (such as the gate line GL2) to the (g+5)^{th} gate line (such as the gate line GL6).

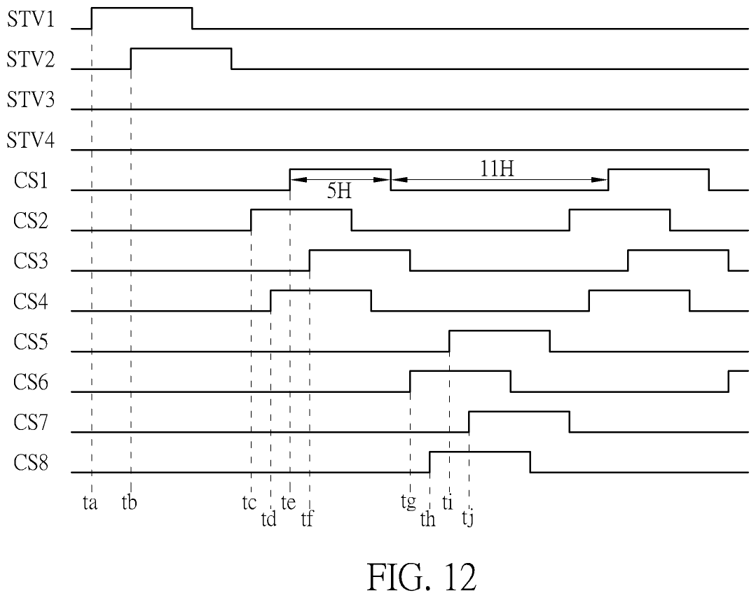

Referring to FIG. 12, FIG. 12 illustrates a timing diagram of a gate driver circuit according to the third embodiment of the present invention. For ease of explanation, FIG. 12 only shows a portion of a frame. The gate driver circuit 1022 is taken as an example in the following description. At time tc, the clock signal CS2 rises from low electric potential to high electric potential. At this time, the shift register SR(2) outputs the scan signal OUT(2) to the corresponding gate line GL3 according to the clock signal CS2. At time td, the clock signal CS4 rises from low electric potential to high electric potential. At this time, the shift register SR(4) outputs the scan signal OUT(4) to the corresponding gate line GL7 according to the clock signal CS4. At time te, the clock signal CS1 rises from low electric potential to high electric potential. At this time, the shift register SR(1) outputs the scan signal OUT(1) to the corresponding gate line GL1 according to the clock signal CS1. At time tf, the clock signal CS3 rises from low electric potential to high electric potential. At this time, the shift register SR(3) outputs the scan signal OUT(3) to the corresponding gate line GL5 according to the clock signal CS3.

At time tg, the clock signal CS6 rises from low electric potential to high electric potential. At this time, the shift register SR(6) outputs the scan signal OUT(6) to the corresponding gate line GL11 according to the clock signal CS6. At time th, the clock signal CS8 rises from low electric potential to high electric potential. At this time, the shift register SR(8) outputs the scan signal OUT(8) to the corresponding gate line GL15 according to the clock signal CS8. At time ti, the clock signal CS5 rises from low electric potential to high electric potential. At this time, the shift register SR(5) outputs the scan signal OUT(5) to the corresponding gate line GL9 according to the clock signal CS5. At time tj, the clock signal CS7 rises from low electric potential to high electric potential. At this time, the shift register SR(7) outputs the scan signal OUT(7) to the corresponding gate line GL13 according to the clock signal CS7.

In addition, the gate driver circuit 1021 outputs the scan signals to the gate line GL4, the gate line GL8, the gate line GL2 and the gate line GL6 in sequence according to the scan order SQd during the time tf to the time tg.

Referring to FIG. 13, FIG. 13 schematically illustrates a scan order of a gate driver circuit in a frame according to a fourth embodiment of the present invention. In a frame, the gate driver circuit 1021 and the gate driver circuit 1022 may output the scan signals to the corresponding gate lines according to a scan order SQe in a multihop manner. The scan order SQe may include an order of the gate driver circuits scanning from the g^{th} gate line (such as the gate line GL1), the (g+4)^{th} gate line (such as the gate line GL5), the (g+1)^{th} gate line (such as the gate line GL2), the (g+5)^{th} gate line (such as the gate line GL6), the (g+2)^{th} gate line (such as the gate line GL3), the (g+6)^{th} gate line (such as the gate line GL7), the (g+3)^{th} gate line (such as the gate line GL4) to the (g+7)^{th} gate line (such as the gate line GL8).

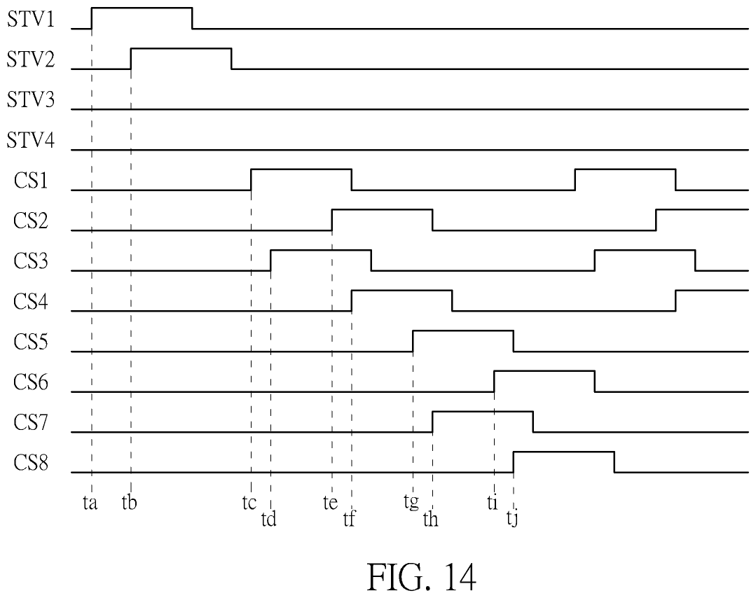

Referring to FIG. 14, FIG. 14 illustrates a timing diagram of a gate driver circuit according to the fourth embodiment of the present invention. The gate driver circuit 1022 is taken as an example in the following description. At time tc, the clock signal CS1 rises from low electric potential to high electric potential. At this time, the shift register SR(1) outputs the scan signal OUT(1) to the corresponding gate line GL1 according to the clock signal CS1. At time td, the clock signal CS3 rises from low electric potential to high electric potential. At this time, the shift register SR(3) outputs the scan signal OUT(3) to the corresponding gate line GL5 according to the clock signal CS3. At time te, the clock signal CS2 rises from low electric potential to high electric potential. At this time, the shift register SR(2) outputs the scan signal OUT(2) to the corresponding gate line GL3 according to the clock signal CS2. At time tf, the clock signal CS4 rises from low electric potential to high electric potential. At this time, the shift register SR(4) outputs the scan signal OUT(4) to the corresponding gate line GL7 according to the clock signal CS4.

The gate driver circuit 1021 outputs the scan signals to the gate line GL2 and the gate line GL6 in sequence according to the scan order SQe during the time td to the time te. In addition, the gate driver circuit 1021 outputs the scan signals to the gate line GL4 and the gate line GL8 in sequence according to the scan order SQe after the scan signal OUT(4) is output to the corresponding gate line GL7 (or during the time tf to the time tg).

The gate driver circuit 1022 is taken as an example again, at time tg, the clock signal CS5 rises from low electric potential to high electric potential. At this time, the shift register SR(5) outputs the scan signal OUT(5) to the corresponding gate line GL9 according to the clock signal CS5. At time th, the clock signal CS7 rises from low electric potential to high electric potential. At this time, the shift register SR(7) outputs the scan signal OUT(7) to the corresponding gate line GL13 according to the clock signal CS7. At time ti, the clock signal CS6 rises from low electric potential to high electric potential. At this time, the shift register SR(6) outputs the scan signal OUT(6) to the corresponding gate line GL11 according to the clock signal CS6. At time tj, the clock signal CS8 rises from low electric potential to high electric potential. At this time, the shift register SR(8) outputs the scan signal OUT(8) to the corresponding gate line GL15 according to the clock signal CS8.

The gate driver circuit 1021 outputs the scan signals to the gate line GL10 and the gate line GL14 in sequence during the time th and the time ti. In addition, the gate driver circuit 1021 outputs the scan signals to the gate line GL12 and the gate line GL16 in sequence after the scan signal OUT(8) is output to the corresponding gate line GL15.

The same as the effect by adopting the scan order SQa, when the gate driver circuit 1021 and the gate driver circuit 1022 output the scan signals to the corresponding gate lines according to the scan order SQc, the scan order SQd or the scan order SQe, the data line DLa may continuously transmit signals to the corresponding sub-pixels, and the number of times that the data line DLa is turned on and turned off to transmit signals may be reduced, thereby reducing the power consumption of the display panel 10.

In addition, in the continuous first frame FR1 and the second frame FR2 (as shown in FIG. 7) in some embodiments, one of the scan order SQa, the scan order SQb, the scan order SQc, the scan order SQd and the scan order SQe may be adopted in the first frame FR1, and another one of the scan order SQa, the scan order SQb, the scan order SQc, the scan order SQd and the scan order SQe may be adopted in the second frame FR2. Therefore, the locations of the horizontal stripes caused by insufficient charging of the signal output by the data line DLa can be different in different frames, such that it is difficult for users to perceive the existence of horizontal stripes, thereby improving the quality of display.

Referring to FIG. 15, FIG. 15 schematically illustrates a scan order of a gate driver circuit in a frame according to a fifth embodiment of the present invention. In a frame, the gate driver circuit 1021 and the gate driver circuit 1022 may output the scan signals to the corresponding gate lines according to a scan order SQf in a multihop manner. In this embodiment, g is equal to 1+16h (g=1+16h), h is an integer greater than or equal to 0, and g is a positive integer greater than or equal to 1. Therefore, g may be 1, 17, 33 . . . , and h is equal to 0 and g is equal to 1 is taken as an example here. The scan order SQf may include an order of the gate driver circuits scanning from the g^{th} gate line (such as the gate line GL1), the (g+4)^{th} gate line (such as the gate line GL5), the (g+8)^{th} gate line (such as the gate line GL9), the (g+12)^{th} gate line (such as the gate line GL13), the (g+2)^{th} gate line (such as the gate line GL3), the (g+6)^{th} gate line (such as the gate line GL7), the (g+10)^{th} gate line (such as the gate line GL11), the (g+14)^{th} gate line (such as the gate line GL15), the (g+1)^{th} gate line (such as the gate line GL2), the (g+5)^{th} gate line (such as the gate line GL6), the (g+9)^{th} gate line (such as the gate line GL10), the (g+13)^{th} gate line (such as the gate line GL14), the (g+3)^{th} gate line (such as the gate line GL4), the (g+7)^{th} gate line (such as the gate line GL8), the (g+11)^{th} gate line (such as the gate line GL12) to the (g+15)^{th} gate line (such as the gate line GL16).

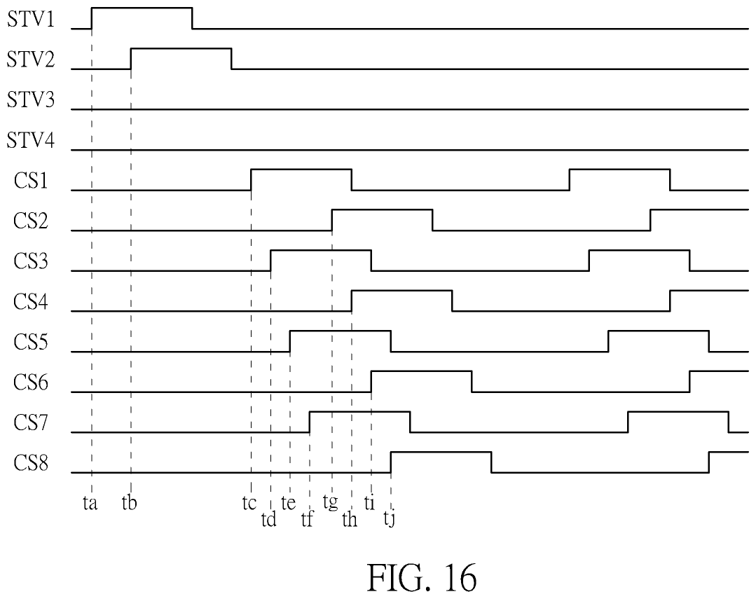

Referring to FIG. 16, FIG. 16 illustrates a timing diagram of a gate driver circuit according to the fifth embodiment of the present invention. The gate driver circuit 1022 is taken as an example in the following description. At time tc, the clock signal CS1 rises from low electric potential to high electric potential. At this time, the shift register SR(1) outputs the scan signal OUT(1) to the corresponding gate line GL1 according to the clock signal CS1. At time td, the clock signal CS3 rises from low electric potential to high electric potential. At this time, the shift register SR(3) outputs the scan signal OUT(3) to the corresponding gate line GL5 according to the clock signal CS3. At time te, the clock signal CS5 rises from low electric potential to high electric potential. At this time, the shift register SR(5) outputs the scan signal OUT(5) to the corresponding gate line GL9 according to the clock signal CS5. At time tf, the clock signal CS7 rises from low electric potential to high electric potential. At this time, the shift register SR(7) outputs the scan signal OUT(7) to the corresponding gate line GL13 according to the clock signal CS7.

At time tg, the clock signal CS2 rises from low electric potential to high electric potential. At this time, the shift register SR(2) outputs the scan signal OUT(2) to the corresponding gate line GL3 according to the clock signal CS2. At time th, the clock signal CS4 rises from low electric potential to high electric potential. At this time, the shift register SR(4) outputs the scan signal OUT(4) to the corresponding gate line GL7 according to the clock signal CS4. At time ti, the clock signal CS6 rises from low electric potential to high electric potential. At this time, the shift register SR(6) outputs the scan signal OUT(6) to the corresponding gate line GL11 according to the clock signal CS6. At time tj, the clock signal CS8 rises from low electric potential to high electric potential. At this time, the shift register SR(8) outputs the scan signal OUT(8) to the corresponding gate line GL15 according to the clock signal CS8.

After the scan signal OUT(8) is output to the corresponding gate line GL15, the gate driver circuit 1021 outputs the scan signals to the gate line GL2, the gate line GL6, the gate line GL10, the gate line GL14, the gate line GL4, the gate line GL8, the gate line GL12 and the gate line GL16 in sequence according to the scan order SQf.

The data line DLa in FIG. 2 is taken as an example. When the gate driver circuit 1021 and the gate driver circuit 1022 output the scan signals to the corresponding gate lines according to the scan order SQf, the order that the data line DLa outputs the gray level signals of different colors is shown in the following table 4.

TABLE 4

| SQf | GL1 | GL5 | GL9 | GL13 | GL3 | GL7 | GL11 | GL15 |
|---|---|---|---|---|---|---|---|---|
| DLa | R | R | R | R | B | B | B | B |
| R | 1 | 1 | 1 | 1 | 0 | 0 | 0 | 0 |
| G | 0 | 0 | 0 | 0 | 0 | 0 | 0 | 0 |
| B | 0 | 0 | 0 | 0 | 1 | 1 | 1 | 1 |
| SQf | GL2 | GL6 | GL10 | GL14 | GL4 | GL8 | GL12 | GL16 |
| DLa | G | G | G | G | R | R | R | R |
| R | 0 | 0 | 0 | 0 | 1 | 1 | 1 | 1 |
| G | 1 | 1 | 1 | 1 | 0 | 0 | 0 | 0 |
| B | 0 | 0 | 0 | 0 | 0 | 0 | 0 | 0 |

As shown in the table 4, in the case of displaying the images of pure red color in the period of driving from the gate line GL1 to the gate line GL16, and when the gate driver circuit 1022 continuously drives the gate line GL1, the gate line GL5, the gate line GL9 and the gate line GL13, or when the gate driver circuit 1021 continuously drives the gate line GL4, the gate line GL8, the gate line GL12 and the gate line GL16, the data line DLa may continuously transmit the gray level signals of red light to four corresponding sub-pixels.

In the case of displaying the images of pure green color, and when the gate driver circuit 1021 continuously drives the gate line GL2, the gate line GL6, the gate line GL10 and the gate line GL14, the data line DLa may continuously transmit the gray level signals of green light to four corresponding sub-pixels.

In the case of displaying the images of pure blue color, and when the gate driver circuit 1022 continuously drives the gate line GL3, the gate line GL7, the gate line GL11 and the gate line GL15, the data line DLa may continuously transmit the gray level signals of blue light to four corresponding sub-pixels.

In the case that the images of pure color (such as green or blue) are displayed, and when the gate driver circuit 1021 and the gate driver circuit 1022 output the scan signals to the corresponding gate lines according to an order of the gate line GL1, the gate line GL2 . . . to the gate line GL8 in a conventional manner (as shown in table 2), the data line DLa needs to be turned on and turned off twice to transmit the gray level signal of green light or blue light in the period of driving from the gate line GL1 to the gate line GL8.

In this embodiment, when the scan signals are output according to the scan order SQf, the data line DLa only needs to be turned on and turned off once to transmit the gray level signal of green light or blue light in the period of driving from the gate line GL1 to the gate line GL16. Therefore, the number of times that the data line DLa is turned on and turned off to transmit gray level signals may be reduced by adopting the scan order SQf, thereby reducing the power consumption of the display panel 10. In some embodiments, the scan order SQf may also be adopted in the first frame FR1 or the second frame FR2 shown in FIG. 7.

In summary, in the driving method of the display panel of this invention, the display region of the display panel may include the structure shown in FIG. 2 and the connecting method of the gate driver circuit shown in FIG. 5. In addition, the gate driver circuit can output the scan signals to the corresponding gate lines in a multihop manner, such that the number of times that the data lines are turned on and turned off to transmit signals may be reduced, thereby reducing the power consumption of the display panel. Moreover, the scan orders of the gate driver circuits can be different from each other in at least two continuous frames. Therefore, the positions of the horizontal stripes caused by insufficient charging of the signal output by the data line are different in different frames, such that it is difficult for users to perceive the existence of horizontal stripes, thereby improving the quality of display.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method of a display panel, comprising:
providing a display panel, the display panel comprising:
a plurality of sub-pixels arranged in an array;
a plurality of gate lines arranged side by side along a first direction, wherein each of the gate lines is electrically connected to a portion of the sub-pixels; and
two gate driver circuits, wherein each of the gate driver circuits comprises a plurality of clock signal lines, and each of the gate lines is electrically connected to one of the gate driver circuits;
controlling the gate driver circuits through the clock signal lines to output a plurality of scan signals to the gate lines in a plurality of frames; and
making the gate driving circuits have a first scan order in a first frame in the frames, making the gate driving circuits have a second scan order in a second frame in the frames, and the first scan order is different from the second scan order, wherein the first frame is a k^{th} frame in the frames, the second frame is a (k+1)^{th} frame in the frames, and k is a positive integer greater than or equal to 1.

2. The driving method of the display panel of claim 1, wherein the display panel further comprises a plurality of data lines arranged side by side along a second direction and extended along the first direction, the second direction is not parallel to the first direction, one of the data lines is disposed between two adjacent sub-pixel columns, the one of the data lines is electrically connected to a second sub-pixel adjacent to the one of the data lines and located at a side of the one of the data lines in a m^{th} sub-pixel row, the one of the data lines is electrically connected to a first sub-pixel adjacent to the one of the data lines and located at another side of the one of the data lines in the m^{th} sub-pixel row, the one of the data lines is electrically connected to a first sub-pixel adjacent to the one of the data lines and located at the side of the one of the data lines in a (m+1)^{th} sub-pixel row, the one of the data lines is electrically connected to a second sub-pixel adjacent to the one of the data lines and located at the another side of the one of the data lines in the (m+1)^{th} sub-pixel row, the one of the data lines is electrically connected to a second sub-pixel adjacent to the one of the data lines and located at the side of the one of the data lines in a (m+2)^{th} sub-pixel row, the one of the data lines is electrically connected to a first sub-pixel adjacent to the one of the data lines and located at the another side of the one of the data lines in the (m+2)^{th} sub-pixel row, the one of the data lines is electrically connected to a first sub-pixel adjacent to the one of the data lines and located at the side of the one of the data lines in a (m+3)^{th} sub-pixel row, and the one of the data lines is electrically connected to a second sub-pixel adjacent to the one of the data lines and located at the another side of the one of the data lines in the (m+3)^{th} sub-pixel row, wherein m is equal to 1+4k (m=1+4k), k is an integer greater than or equal to 0, and m is a positive integer greater than or equal to 1.

3. The driving method of the display panel of claim 2, wherein the gate lines are extended along the second direction, a g^{th} gate line of the gate lines is electrically connected to the second sub-pixel adjacent to the one of the data lines and located at the side of the one of the data lines in the m^{th} sub-pixel row, a (g+1)^{th} gate line of the gate lines is electrically connected to the first sub-pixel adjacent to the one of the data lines and located at the another side of the one of the data lines in the m^{th} sub-pixel row, a (g+2)^{th} gate line of the gate lines is electrically connected to the first sub-pixel adjacent to the one of the data lines and located at the side of the one of the data lines in the (m+1)^{th} sub-pixel row, a (g+3)^{th} gate line of the gate lines is electrically connected to the second sub-pixel adjacent to the one of the data lines and located at the another side of the one of the data lines in the (m+1)^{th} sub-pixel row, a (g+4)^{th} gate line of the gate lines is electrically connected to the second sub-pixel adjacent to the one of the data lines and located at the side of the one of the data lines in the (m+2)^{th} sub-pixel row, a (g+5)^{th} gate line of the gate lines is electrically connected to the first sub-pixel adjacent to the one of the data lines and located at the another side of the one of the data lines in the (m+2)^{th} sub-pixel row, a (g+6)^{th} gate line of the gate lines is electrically connected to the first sub-pixel adjacent to the one of the data lines and located at the side of the one of the data lines in the (m+3)^{th} sub-pixel row, and a (g+7)^{th} gate line of the gate lines is electrically connected to the second sub-pixel adjacent to the one of the data lines and located at the another side of the one of the data lines in the (m+3)^{th} sub-pixel row, wherein g is equal to 1+8h (g=1+8h), h is an integer greater than or equal to 0, and g is a positive integer greater than or equal to 1.

4. The driving method of the display panel of claim 3, wherein the first scan order or the second scan order comprises an order scanning from the g^{th} gate line, the (g+4)^{th} gate line, the (g+1)^{th} gate line, the (g+5)^{th} gate line, the (g+2)^{th} gate line, the (g+6)^{th} gate line, the (g+3)^{th} gate line to the (g+7)^{th} gate line.

5. The driving method of the display panel of claim 3, wherein the first scan order or the second scan order comprises an order scanning from the g^{th} gate line, the (g+4)^{th} gate line, the (g+2)^{th} gate line, the (g+6)^{th} gate line, the (g+1)^{th} gate line, the (g+5)^{th} gate line, the (g+3)^{th} gate line to the (g+7)^{th} gate line.

6. The driving method of the display panel of claim 3, wherein the first scan order or the second scan order comprises an order scanning from the (g+4)^{th} gate line, the g^{th} gate line, the (g+6)^{th} gate line, the (g+2)^{th} gate line, the (g+5)^{th} gate line, the (g+1)^{th} gate line, the (g+7)^{th} gate line to the (g+3)^{th} gate line.

7. The driving method of the display panel of claim 3, wherein the first scan order or the second scan order comprises an order scanning from the (g+6)^{th} gate line, the (g+2)^{th} gate line, the (g+4)^{th} gate line, the g^{th} gate line, the (g+7)^{th} gate line, the (g+3)^{th} gate line, the (g+5)^{th} gate line to the (g+1)^{th} gate line.

8. The driving method of the display panel of claim 3, wherein the first scan order or the second scan order comprises an order scanning from the (g+2)^{th} gate line, the (g+6)^{th} gate line, the g^{th} gate line, the (g+4)^{th} gate line, the (g+3)^{th} gate line, the (g+7)^{th} gate line, the (g+1)^{th} gate line to the (g+5)^{th} gate line.

9. The driving method of the display panel of claim 1, wherein each of the gate driver circuits comprises a plurality of shift registers, each level of the shift registers is electrically connected to one of the gate lines, wherein an i^{th}-level shift register is electrically connected to an (i−4)^{th}-level shift register and an (i+4)^{th}-level shift register, wherein i is a positive integer greater than or equal to 5.

10. The driving method of the display panel of claim 1, wherein the display panel further comprises a plurality of data lines arranged side by side along a second direction and extended along the first direction, the second direction is not parallel to the first direction, the sub-pixels are arranged along the first direction to form a plurality of sub-pixel columns, and the sub-pixels are arranged along the second direction to form a plurality of sub-pixel rows, two of the sub-pixel columns are disposed between adjacent two of the data lines, and two of the gate lines are disposed between adjacent two of the sub-pixel rows.
